(19) United States
(12) Patent Application Publication
(10) Pub. No.: US 2026/0337066 A1
(43) Pub. Date: Oct. 29, 2026

(54) WATER TREATMENT DEVICE AND DISHWASHER HAVING THE SAME

(71) Applicant: SAMSUNG ELECTRONICS CO., LTD., Suwon-si (KR)

(72) Inventors: Gimun GWAK, Suwon-si (KR); Johannes BÜSING, Suwon-si (KR); Jungha PARK, Suwon-si (KR)

(73) Assignee: SAMSUNG ELECTRONICS CO., LTD., Suwon-si (KR)

(21) Appl. No.: 19/631,043

(22) Filed: Mar. 27, 2026

Related U.S. Application Data
(63) Continuation of application No. PCT/KR2026/004218, filed on Mar. 16, 2026.

(30) Foreign Application Priority Data
Apr. 29, 2025 (KR) 10-2025-0056759
Jul. 4, 2025 (KR) 10-2025-0090368

(51) Int. Cl. C02F 1/469

(52) U.S. Cl. CPC C02F 1/4691; C02F 2307/12

(57) ABSTRACT

A water treatment device including a case including an inlet port and an outlet port; a plurality of deionization electrodes, accommodated in the case and configured to adsorb ionic substances, including a first deionization electrode and a second deionization electrode; a first terminal connected to the first deionization electrode; a second terminal connected to the second deionization electrode; a contact terminal between the first deionization electrode and the second deionization electrode connected by contacting at least the first deionization electrode and the second deionization electrode along a direction in which the first deionization electrode and the second deionization electrode are arranged relative to each other within the case; and a pin terminal coupleable to the contact terminal and configured to connect to an outside power source.

### CROSS-REFERENCE TO RELATED APPLICATIONS

This application is a continuation application, under 35 U.S.C. § 111(a), of International Application No. PCT/KR2026/004218, filed on Mar. 16, 2026, which is based on and claims priority under 35 U.S.C. § 119 to Korean Patent Application No. 10-2025-0056759, filed on Apr. 29, 2025 in the Korean Intellectual Property Office and to Korean Patent Application No. 10-2025-0090368, filed on Jul. 4, 2025 in the Korean Intellectual Property Office, the disclosures of which is incorporated by reference herein in its entirety.

### TECHNICAL FIELD

The disclosure relates to a water treatment device and a dishwasher including the same.

### BACKGROUND ART

A dishwasher is a device that uses a high-pressure spray of washing water to wash and dry dishes stored therein. A dishwasher operates such that washing water is sprayed at high pressure inside a washing chamber, in which the dishes are stored, and the sprayed washing water comes into contact with the dishes to wash off foreign matter, such as food residues, from the surface of the dishes.

The dishwasher includes a tub for forming a washing chamber and a sump for storing water, mounted on the bottom of the tub. Water is moved to a spray nozzle by pumping action of a washing pump mounted inside the sump. The water moved to the spray nozzle is sprayed at high pressure through jets formed in the spray nozzle. As the water sprayed at high pressure strikes the surface of dishes, dirt such as food residues on the dishes falls to the bottom of the tub.

The dishwasher may include a water treatment device capable of converting raw water supplied from a water source into soft water. For example, the water treatment device may include a capacitive deionization (CDI) device. The water treatment device may generate soft water by adsorbing ionic substances contained in the raw water.

### DISCLOSURE

### Technical Problem

An embodiment of the present disclosure provides an improved water treatment device capable of efficiently softening raw water, and a dishwasher including the same.

An embodiment of the present disclosure provides an improved water treatment device capable of efficiently performing a water treatment operation even when a relatively low voltage is applied, and a dishwasher including the same.

An embodiment of the present disclosure provides an improved water treatment device capable of efficiently reducing and/or prevent damage to a deionization electrode, and a dishwasher including the same.

An embodiment of the present disclosure provides an improved water treatment device capable of stably connecting a terminal to a deionization electrode even when tolerances between components occur, and a dishwasher including the same.

An embodiment of the present disclosure provides an improved water treatment device capable of efficiently sealing a gap between a pin terminal and a case, and a dishwasher including the same.

An embodiment of the present disclosure provides an improved water treatment device capable of facilitating coupling of a contact terminal to a pin terminal, and a dishwasher including the same.

Technical tasks to be achieved in this document are not limited to the technical tasks mentioned above, and other technical tasks not mentioned will be clearly understood by those skilled in the art from the description below.

### Technical Solution

A water treatment device according to an embodiment of the present disclosure may include: a case including an inlet port and an outlet port; a plurality of deionization electrodes accommodated in the case and configured to adsorb ionic substances from water entering the case through the inlet port, the plurality of deionization electrodes including a first deionization electrode and a second deionization electrode arranged in a first direction relative to each other; a first terminal electrically connected to the first deionization electrode; a second terminal electrically connected to the second deionization electrode; a contact terminal disposed between the first deionization electrode and the second deionization electrode inside the case, and configured to be electrically connected by contacting each of the first deionization electrode and the second deionization electrode in the first direction; and a pin terminal coupled to the contact terminal and configured to electrically connect the contact terminal to a power source outside the case.

A dishwasher according to an embodiment of the present disclosure may include: a tub; a spraying device configured to spray washing water into an interior of the tub; a sump configured to receive washing water to be supplied to the spraying device; and a water treatment device configured to treat washing water to be supplied to the sump. The water treatment device may include: a case; a first deionization electrode accommodated in the case; a second deionization electrode disposed in a first direction of the first deionization electrode; a first terminal in contact with one side of the first deionization electrode; a second terminal in contact with one side of the second deionization electrode; a contact terminal in contact with the other side of the first deionization electrode and the other side of the second deionization electrode in the first direction inside the case; and a pin terminal configured to electrically connect the contact terminal to a power source outside the case, wherein the pin terminal is coupled to the contact terminal in a second direction different from the first direction.

A water treatment device according to an embodiment of the present disclosure may include: a case including an inlet port and an outlet port; a deionization electrode accommodated in the case and configured to adsorb ionic substances from water entering the case through the inlet port; a contact terminal in contact with the deionization electrode inside the case and electrically connected to the deionization electrode; and a pin terminal configured to electrically connect the contact terminal to a power source, wherein the pin terminal is configured to movably support the contact terminal in a first direction relative to the case and hold the contact terminal to restrict movement of the contact terminal in a second direction different from the first direction.

A water treatment device according to an embodiment of the present disclosure may include: a case including an inlet port configured to allow water to be introduced into the water treatment device and an outlet port configured to allow the water to be discharged from the water treatment device; a plurality of deionization electrodes to be accommodated in the case and configured to adsorb ionic substances from the water entering through the inlet port, the plurality of deionization electrodes comprising a first deionization electrode and a second deionization electrode; a first terminal to be electrically connected to the first deionization electrode; a second terminal to be electrically connected to the second deionization electrode; a contact terminal, between the first deionization electrode and the second deionization electrode, configured to be electrically connected by contacting at least the first deionization electrode and the second deionization electrode along a direction in which the first deionization electrode and the second deionization electrode are arranged relative to each other within the case; and a pin terminal, coupleable to the contact terminal, configured to electrically connect at least one of the contact terminal, the first deionization electrode and the second deionization electrode to a power source, the power source configured to be outside the case.

### DESCRIPTION OF DRAWINGS

FIG. 1 is a perspective view of a dishwasher according to an embodiment of the present disclosure.

FIG. 2 is a cross-sectional view of the dishwasher according to an embodiment of the present disclosure.

FIG. 3 is a perspective view illustrating various configurations disposed inside a main body of the dishwasher according to an embodiment of the present disclosure.

FIG. 4 is a perspective view illustrating a tub, and a sump and a water treatment device mounted on the tub of the dishwasher according to an embodiment of the present disclosure.

FIG. 5 is a view illustrating a connection relationship and a flow of washing water among the sump, a case break, and the water treatment device of the dishwasher according to an embodiment of the present disclosure.

FIG. 6 is a perspective view illustrating the case break and the water treatment device of the dishwasher according to an embodiment of the present disclosure.

FIG. 7 is a perspective view illustrating the water treatment device of the dishwasher according to an embodiment of the present disclosure.

FIG. 8 is an exploded perspective view illustrating the water treatment device of the dishwasher according to an embodiment of the present disclosure.

FIG. 9 is a cross-sectional perspective view illustrating the water treatment device of the dishwasher according to an embodiment of the present disclosure.

FIG. 10 is a schematic view illustrating a process of softening water by the water treatment device of the dishwasher according to an embodiment of the present disclosure.

FIG. 11 is a schematic view illustrating a process of removing scale from the water treatment device of the dishwasher according to an embodiment of the present disclosure.

FIG. 12 is a view illustrating various configurations, such as a deionization electrode and a plurality of terminals included in the water treatment device of the dishwasher according to an embodiment of the present disclosure.

FIG. 13 is a cross-sectional view illustrating the water treatment device of the dishwasher according to an embodiment of the present disclosure.

FIG. 14 is an exploded perspective view illustrating various configurations such as a case, a pin terminal, a contact terminal, and a pin terminal seal included in the water treatment device of the dishwasher according to an embodiment of the present disclosure.

FIG. 15 is an enlarged cross-sectional view illustrating a part of the water treatment device of the dishwasher according to an embodiment of the present disclosure.

FIG. 16 is an enlarged cross-sectional view illustrating a part of the water treatment device of the dishwasher according to an embodiment of the present disclosure.

FIG. 17 is an enlarged cross-sectional view illustrating a part of the water treatment device of the dishwasher according to an embodiment of the present disclosure.

FIG. 18 is an enlarged cross-sectional view illustrating a part of the water treatment device of the dishwasher according to an embodiment of the present disclosure.

FIG. 19 is a view illustrating various configurations such as a pin terminal and a contact terminal included in the water treatment device of the dishwasher according to an embodiment of the present disclosure, showing a process of coupling the contact terminal to the pin terminal.

FIG. 20 is a cross-sectional view illustrating various configurations such as a pin terminal and a contact terminal included in the water treatment device of the dishwasher according to an embodiment of the present disclosure.

### DETAILED DESCRIPTION OF THE EMBODIMENTS

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Hereinafter, various embodiments of the disclosure will be described in detail with reference to the accompanying drawings.

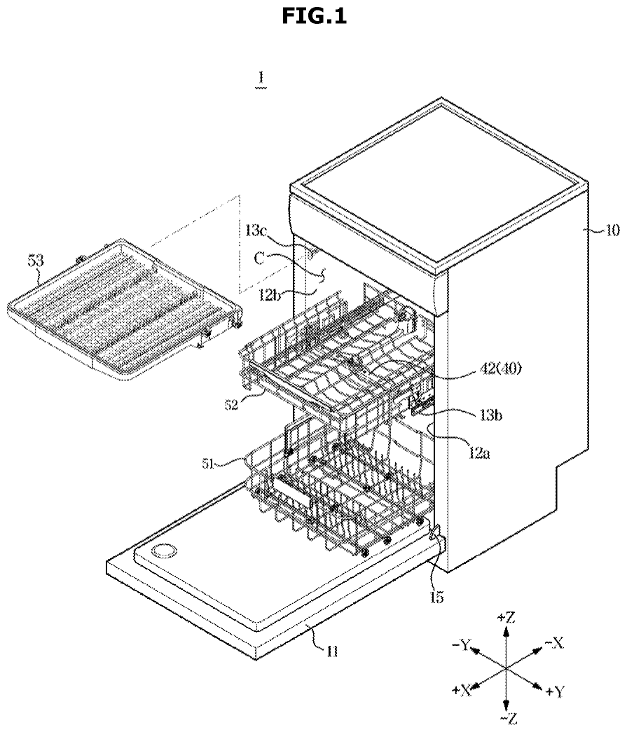

In describing various embodiments of the present disclosure with reference to FIGS. 1 to 20, terms such as “front”, “rear”, “upper”, “lower”, “up-and-down direction”, “left-to-right direction”, etc. used in the following description are defined based on the drawings, and the shape and position of each component are not limited by these terms. For example, the term “front-to-back direction” below may refer to a direction parallel to an X-axis based on the drawings, and “front” and “rear” may refer to a +X direction and a −X direction, respectively, based on the drawings. For example, “vertical direction (up-and-down direction)” may refer to a direction parallel to a Z-axis based on the drawings, and “upper” and “lower” may refer to a +Z direction and a −Z direction, respectively, based on the drawings. For example, the term “horizontal direction (left-to-right direction)” below may refer to a direction parallel to a Y-axis based on the drawings, and “left direction” and “right direction” may refer to a −Y direction and a +Y direction, respectively, based on the drawings.

With reference to FIGS. 1 to 20, a dishwasher will be described below as an example of an appliance that may include a water treatment device according to various embodiments of the present disclosure, but embodiments of the present disclosure are not limited thereto, and water treatment devices according to embodiments of the present disclosure may be included in a variety of appliances that have or require the function of receiving and treating raw water.

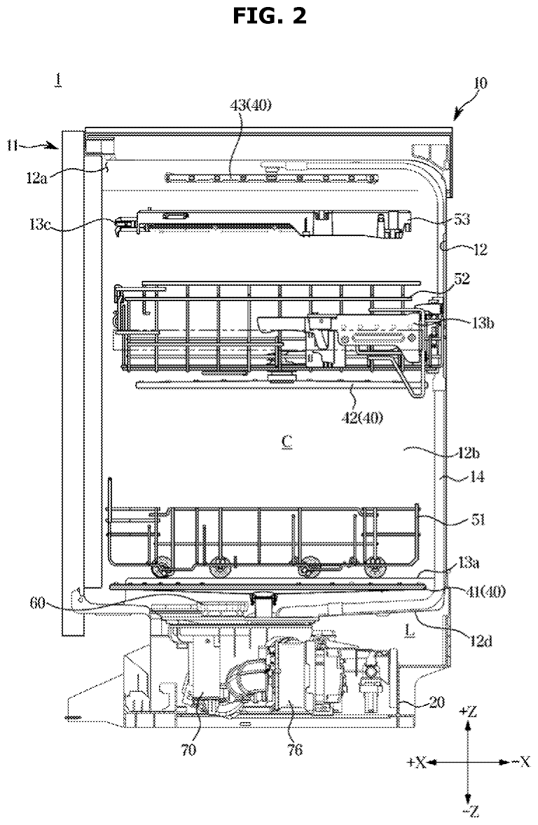

FIG. 1 is a perspective view of a dishwasher according to an embodiment of the present disclosure. FIG. 2 is a cross-sectional view of the dishwasher according to an embodiment of the present disclosure.

Referring to FIGS. 1 and 2, a dishwasher 1 according to an embodiment of the present disclosure may include a main body 10. The main body 10 may form an exterior of the dishwasher 1. Various configurations for operation of the dishwasher 1 may be disposed inside the main body 10.

The dishwasher 1 may include a tub 12. The tub 12 may be disposed inside the main body 10. The tub 12 may be coupled to an interior of the main body 10.

The tub 12 may include a washing chamber C. The washing chamber C may be formed inside the tub 12. The washing chamber C may be defined as an inner space of the tub 12. The washing chamber C may be defined as a space in which tableware is stored, washed and/or dried.

The tub 12 may have an opening 12a. The opening 12a may be formed on one side of the tub 12. The washing chamber C formed inside the tub 12 may be opened on one side by the opening 12a. Tableware may be inserted into and stored in the washing chamber C or withdrawn from the washing chamber C through the opening 12a. For example, the opening 12a may be provided in the front (+X direction) of the tub 12. For example, the tub 12 may have a box shape with a substantially open front (+X direction).

The dishwasher 1 may include a door 11. The door 11 may be configured to open or close the tub 12. The door 11 may be configured to open or close the opening 12a of the tub 12. The door 11 may be configured to open or close the washing chamber C.

The door 11 may be mounted to the main body 10. For example, the door 11 may be mounted to a front surface of the main body 10. For example, the door 11 may be rotatably mounted to the main body 10. For example, the door 11 may be rotatably coupled to the main body 10 by a hinge 15.

For example, the hinge 15 may connect a lower portion of the door 11 to a lower portion of the main body 10. For example, the door 11 may be configured to be rotatable relative to the main body 10 about a rotation axis extending in the left-to-right direction (Y).

The dishwasher 1 may include a storage container configured to receive tableware. The storage container may be disposed inside the tub 12. The storage container may be disposed in the washing chamber C. For example, the storage container may be mounted to an inner wall of the tub 12. For example, the storage container may be mounted on a side wall 12b of the tub 12.

According to an embodiment, the storage container may include a plurality of baskets 51, 52, and 53. The plurality of baskets 51, 52, and 53 may be configured to accommodate a variety of tableware.

According to an embodiment, the storage container may include an intermediate basket 52. The intermediate basket may be disposed at a substantially intermediate height in the up-and-down direction (Z-direction) of the dishwasher 1. The intermediate basket 52 may be inserted into the washing chamber C or withdrawn from the washing chamber C through the opening 12a of the tub 12. For example, the intermediate basket 52 may be movable in the substantially front-to-back direction (X-direction) relative to the tub 12. For example, the intermediate basket 52 may be configured to be supported on an intermediate guide rack 13b. For example, the intermediate basket 52 may be configured to be slidably movable by the intermediate guide rack 13b. For example, the intermediate guide rack 13b may be installed inside the side wall 12b of the tub 12. However, the embodiment of the present disclosure is not limited thereto, and in various embodiments, the intermediate basket 52 may be supported by various configurations within the tub 12.

According to an embodiment, the storage container may include a lower basket 51. The lower basket 51 may be disposed at a substantially lower portion in the up-and-down direction (Z-direction) of the dishwasher 1. For example, the lower basket 51 may be disposed below the intermediate basket 52. The lower basket 51 may be inserted into the washing chamber C or withdrawn from the washing chamber C through the opening 12a of the tub 12. For example, the lower basket 51 may be movable in the substantially front-to-back direction (X-direction) relative to the tub 12. For example, the lower basket 51 may be configured to be supported on a lower guide rack 13a. For example, the lower basket 51 may be configured to be slidably movable by the lower guide rack 13a. For example, the lower guide rack 13a may be installed inside the side wall 12b of the tub 12. However, the embodiment of the present disclosure is not limited thereto, and in various embodiments, the lower basket 51 may be supported by various configurations within the tub 12.

The lower basket 51 and the intermediate basket 52 may accommodate relatively bulky tableware. However, the types of tableware that may be stored in the lower basket 51 and the intermediate basket 52 may not be limited to relatively bulky tableware.

According to an embodiment, the storage container 50 may include an upper basket 53. The upper basket 53 may be disposed at a substantially upper portion in the up-and-down direction (Z-direction) of the dishwasher 1. In an example, the upper basket 53 may be formed in a rack assembly shape to accommodate relatively low bulky tableware. For example, the upper basket 53 may store cooking utensils or cutlery, such as ladles, knives, flippers, and the like. For example, the upper basket 53 may store small cups, such as espresso mugs. However, the types of tableware that may be stored in the upper basket 53 are not limited to the above examples.

The upper basket 53 may be inserted into the washing chamber C or withdrawn from the washing chamber C through the opening 12a of the tub 12. For example, the upper basket 53 may be movable in the substantially front-to-back direction (X-direction) relative to the tub 12. The upper basket 53 may be configured to be supported on an upper guide rack 13c. For example, the upper basket 53 may be configured to be movable slidably by the upper guide rack 13c. For example, the upper guide rack 13c may be installed inside the side wall 12b of the tub 12. However, the embodiment of the present disclosure is not limited thereto, and in various embodiments, the upper basket 53 may be supported by various configurations within the tub 12.

While FIGS. 1 and 2 are described with reference to an embodiment in which the plurality of baskets 51, 52, and 53 are arranged in the up-and-down direction (Z-direction) relative to each other, embodiments of the present disclosure are not limited thereto, and in various embodiments, the storage container may include baskets arranged in various ways. The lower basket 51, the intermediate basket 52, and the upper basket 53 described above are defined and named for ease of description with reference to a relative position of each of the plurality of baskets 51, 52, and 53, and the expressions “lower”, “intermediate”, and “upper” do not limit the position of the baskets.

While FIGS. 1 and 2 are described with reference to an embodiment in which the storage container includes three baskets 51, 52, and 53, embodiments of the present disclosure are not limited thereto, and in various embodiments, the storage container may include only a single basket, or may include two or four or more baskets.

The dishwasher 1 may include a spraying device 40 (e.g., a sprayer). The spraying device 40 may be configured to spray washing water. The spraying device 40 may be configured to spray washing water into the interior of the tub 12. The spraying device 40 may be configured to spray washing water into the washing chamber C. The spraying device 40 may spray washing water toward the tableware stored in the washing chamber C. The spraying device 40 may be supplied with washing water from a sump 70, which will be described later. Here, the washing water may include water for washing tableware, and may include water mixed with a detergent and/or rinse, and water not mixed with detergent and/or rinse.

The spraying device 40 may include at least one spraying unit. For example, the spraying device 40 may include a plurality of spraying units 41, 42, and 43.

For example, the spraying device 40 may include a first spraying unit 41 disposed below the lower basket 51 in the up-and-down direction (Z-direction) of the dishwasher 1. For example, the spraying device 40 may include a second spraying unit 42 disposed above the lower basket 51 and below the intermediate basket 52 in the up-and-down direction (Z-direction) of the dishwasher 1. For example, the spraying device 40 may include a third spraying unit 43 disposed above the upper basket 53 in the up-and-down direction (Z-direction) of the dishwasher 1. However, the embodiments of the present disclosure are not limited thereto, and in various embodiments, the spraying device 40 may include two or fewer or four or more spraying units.

Each of the plurality of spraying units 41, 42, and 43 may be configured to spray washing water while rotating. For example, each of the first spraying unit 41, the second spraying unit 42, and the third spraying unit 43 may be configured to spray washing water while rotating. The plurality of spraying units 41, 42, and 43 may be referred to as a plurality of spraying rotors 41, 42, and 43. The first spraying unit 41, the second spraying unit 42, and the third spraying unit 43 may be referred to as a first spraying rotor 41, a second spraying rotor 42, and a third spraying rotor 43, respectively.

However, in various embodiments, the spraying device 40 may spray washing water in a manner different from the example described above. For example, the first spraying unit 41, unlike the second spraying unit 42 and the third spraying unit 43, may be fixed to one side of a bottom surface 12d of the tub 12. In this case, the first spraying unit 41 may be configured to spray washing water in a substantially horizontal direction by a fixed nozzle, and the washing water sprayed in the substantially horizontal direction from the nozzle of the first spraying unit 41 may be redirected by a diversion assembly disposed inside the washing chamber C and directed upwardly. The diversion assembly may be mounted on a rail and may be configured to be translationally movable along the rail. Meanwhile, although the first spraying unit 41 has been described as an example, the second spraying unit 42 and the third spraying unit 43 may also be configured to spray washing water using fixed nozzles, as in the examples described above.

The dishwasher 1 may include a sump 70. The sump 70 may be configured to receive washing water. For example, the sump 70 may be configured to receive washing water to be supplied to the spraying device 40. For example, the sump 70 may supply washing water to at least one of the plurality of spraying units 41, 42, and 43. For example, the sump 70 may selectively supply washing water to the plurality of spraying units 41, 42, and 43.

The sump 70 may be configured to store washing water in the tub 12. The sump 70 may be configured to collect washing water from the washing chamber C. In an example, to facilitate smooth collection of washing water by the sump 70, the bottom surface 12d of the tub 12 may be inclined downwardly toward the sump 70. Washing water from the washing chamber C may flow down along the slope of the bottom surface 12d of the tub 12 and smoothly enter the sump 70.

The dishwasher 1 may include a circulation pump 76 configured to pump the washing water stored in the sump 70. The circulation pump 76 may pump the washing water stored in the sump 70 and supply the pumped washing water to the spraying device 40. According to an embodiment, the circulation pump 76 may be provided as one configuration of the sump 70. The circulation pump 76 may be disposed in a machine chamber L.

The dishwasher 1 may include a pipe 14. The pipe 14 may connect the sump 70 and the spraying device 40. The pipe 14 may connect the sump 70 and the plurality of spraying units 41, 42, and 43. The pipe 14 may be configured to guide washing water from the sump 70 to the spraying device 40. The pipe 14 may be configured to guide washing water from the sump 70 to the plurality of spraying units 41, 42, and 43. In an example, the pipe 14 may include a shape extending in the substantially up-and-down direction (Z-direction).

The dishwasher 1 may include the machine chamber L. The machine chamber L may be a space disposed below the tub 12. The machine chamber L may be disposed below the washing chamber C. The machine chamber L may be partitioned from the washing chamber C. The dishwasher 1 may include a base frame 20 that forms the machine chamber L. The base frame 20 may be mounted to a lower portion of the main body 10. The base frame 20 may be mounted to a lower portion of the tub 12. In the machine chamber L, a configuration for circulating washing water may be disposed.

At least a portion of the sump 70 may be disposed in the machine chamber L. For example, a majority of the sump 70 may be disposed in the machine chamber L. For example, a volume of the sump 70 that is disposed in the washing chamber C may be smaller than a volume of the sump 70 that is disposed in the machine chamber L. By reducing the volume of the sump 70 that occupies the washing chamber C, a space inside the washing chamber C may be secured. Thus, the capacity of the washing chamber C may be increased, thereby improving the storage capacity of tableware.

The dishwasher 1 may include a filter 60. The filter 60 may be configured to filter out foreign matter contained in the washing water entering the sump 70. The washing water filtered by the filter 60 may be delivered to the spraying device 40 by the sump 70. The filter 60 may be detachably mounted to the sump 70. At least a portion of the filter 60 may be disposed inside the sump 70. For example, the filter 60 may include at least one of a fine filter, a coarse filter, or a micro filter.

The configurations of the dishwasher 1 described above with reference to FIGS. 1 and 2 are merely one embodiment of the present disclosure, and in various embodiments, the dishwasher 1 may include various configurations necessary to perform various functions, such as washing and/or drying tableware.

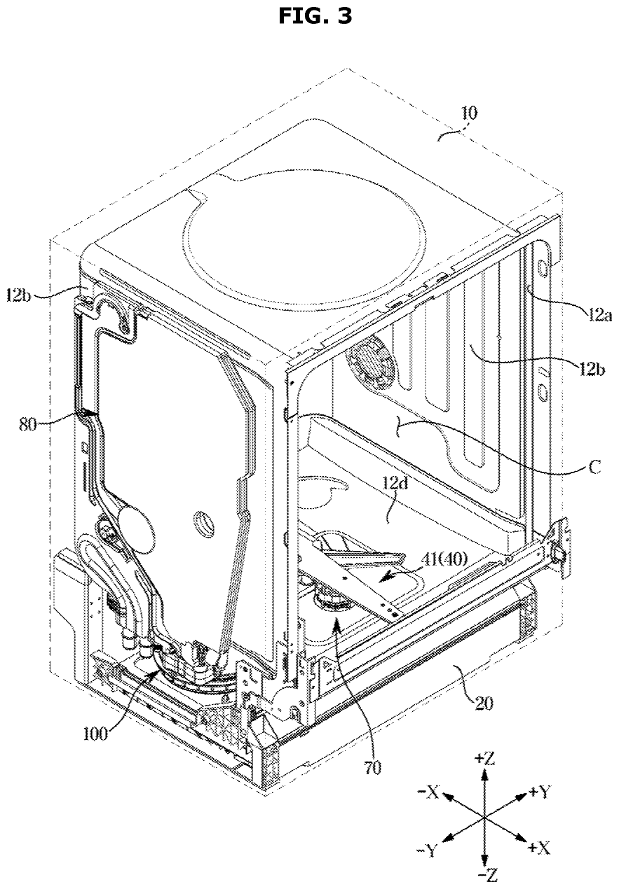

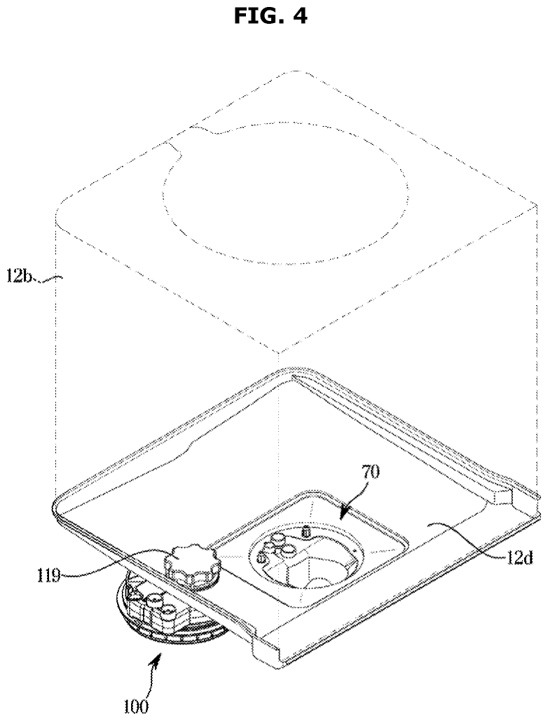

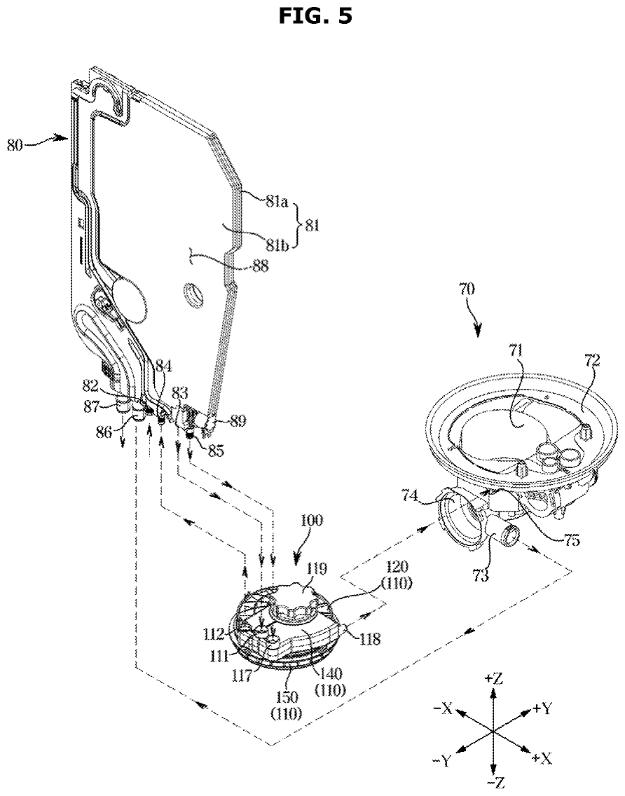

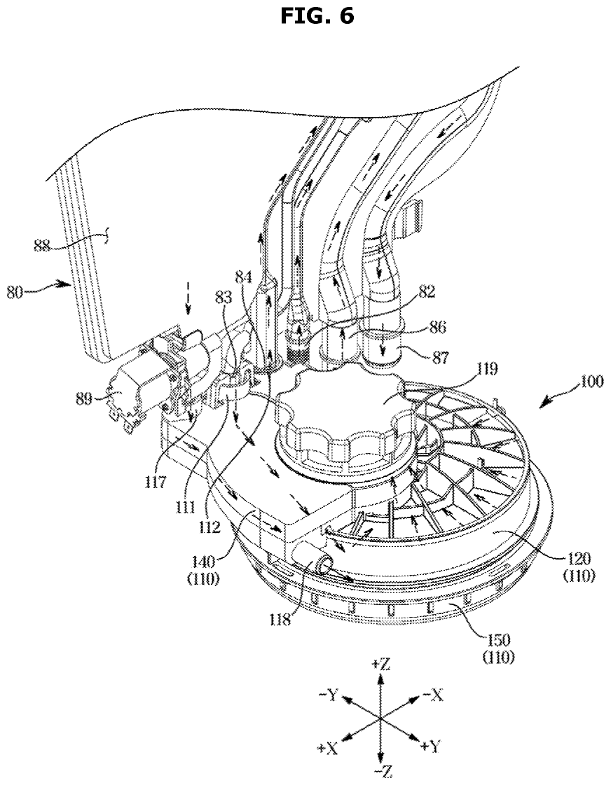

FIG. 3 is a perspective view illustrating various configurations disposed inside a main body of the dishwasher according to an embodiment of the present disclosure. FIG. 4 is a perspective view illustrating a tub, and a sump and a water treatment device mounted to the tub of the dishwasher according to an embodiment of the present disclosure. FIG. 5 is a diagram illustrating a connection relationship and a flow of washing water between the sump, a case break, and the water treatment device of the dishwasher according to an embodiment of the present disclosure. FIG. 6 is a perspective view illustrating the case break and the water treatment device of the dishwasher according to an embodiment of the present disclosure.

Referring to FIGS. 3 to 6, the dishwasher 1 according to an embodiment of the present disclosure may include a water treatment device 100. The water treatment device 100 may be configured to perform water treatment on washing water. The water treatment device 100 may be configured to treat washing water to be supplied to the spraying device 40. The water treatment device 100 may be configured to treat washing water to be supplied to the sump 70. A flow path through which water flows may be formed in the water treatment device 100.

The water treatment device 100 may be configured to treat raw water provided from a water source. According to an embodiment, the raw water provided from the water source may include hard water having a relatively high percentage of ionic substances, and the water treatment device 100 may be configured to remove the ionic substances from the raw water and convert the raw water into soft water. The water treatment device 100 may be configured to provide soft water, from which ionic substances have been removed from the raw water, to the sump 70. In other words, the water treatment device 100 may soften the washing water. In addition, the water treatment device 100 may treat the washing water in various ways.

According to an embodiment, the water treatment device 100 may include a capacitive deionization (CDI) unit.

The water treatment device 100 may include an inlet port 111. The inlet port 111 may be configured to allow raw water to enter the water treatment device 100. For example, raw water from a case break 80, which will be described later, may be introduced into the water treatment device 100 via the inlet port 111.

The water treatment device 100 may include an outlet port 112. The outlet port 112 may be configured to allow treated water (e.g., soft water) that has passed through the water treatment device 100 to be discharged from the water treatment device 100. For example, the water treated by the water treatment device 100 may be supplied to the case break 80 via the outlet port 112.

The water treatment device 100 may include a tank connection port 117 and a sump connection port 118. The tank connection port 117 may be connected to a water tank 88, which will be described later. The sump connection port 118 may be connected to the sump 70. For example, the washing water stored in the water tank 88, which will be described later, may be introduced into the water treatment device 100 through the tank connection port 117, and the washing water introduced into the water treatment device 100 may be discharged through the sump connection port 118 and fed into the sump 70.

The water treatment device 100 may be accommodated within the main body 10. For example, the water treatment device 100 may be disposed on a lower side of the tub 12. For example, at least a portion of the water treatment device 100 may be disposed below the bottom surface 12d of the tub 12. For example, at least a portion of the water treatment device 100 may be disposed in the machine chamber L.

A detailed description of the water treatment device 100 will be described later.

According to an embodiment, the dishwasher 1 may include the case break 80. The case break 80 may include various flow paths through which water flows. For example, the case break 80 may include a flow path through which raw water provided from a water source flows. For example, the case break 80 may include a flow path through which washing water (e.g., soft water) that has passed through the water treatment device 100 flows. For example, the case break 80 may include a flow path through which water collected and drained by the sump 70 after a washing process flows.

The case break 80 may be connected to configurations, such as a water source, the water treatment device 100, and the sump 70. For example, the case break 80 may be connected to a water source to receive raw water from the water source. For example, the case break 80 may be connected to the water treatment device 100 to supply raw water to the water treatment device 100 and receive treated washing water (e.g., soft water) from the water treatment device 100. For example, the case break 80 may be connected to the sump 70 to supply washing water to the sump 70. For example, the case break 80 may be connected to the water treatment device 100 to supply washing water to the water treatment device 100, and the washing water may pass through the water treatment device 100 and be supplied to the sump 70. For example, the case break 80 may be connected to the sump 70 to receive water collected and drained by the sump 70 after a washing process and then discharge the water to the outside of the main body 10. For example, the case break 80 may be connected to configurations, such as the water source, the water treatment device 100, and the sump 70, by a hose.

The case break 80 may include a raw water inlet 82. The raw water inlet 82 may be configured to allow raw water to be introduced into the case break 80. For example, the raw water inlet 82 may be connected to a water source, and the raw water provided from the water source may flow through the raw water inlet 82 into the case break 80.

The case break 80 may include a raw water outlet 83. The raw water outlet 83 may be configured to allow raw water within the case break 80 to be discharged. For example, the raw water outlet 83 may be connected to the water treatment device 100 (e.g., the inlet port 111), and the raw water within the case break 80 may be discharged through the raw water outlet 83 and fed to the water treatment device 100.

The case break 80 may include a soft water inlet 84. The soft water inlet 84 may be configured to allow soft water treated by the water treatment device 100 to flow into the case break 80. For example, the soft water inlet 84 may be connected to the water treatment device 100 (e.g., the outlet port 112), and the soft water treated and discharged by the water treatment device 100 may be fed into the case break 80 via the soft water inlet 84.

The case break 80 may include a soft water outlet 85. The soft water outlet 85 may be configured to allow soft water (e.g., washing water stored in the water tank 88) within the case break 80 to be discharged. For example, the soft water outlet 85 may be connected to the water treatment device 100 (e.g., the tank connection port 117), and the soft water discharged through the soft water outlet 85 may be introduced into the water treatment device 100 and then supplied to the sump 70. Alternatively, for example, the soft water outlet 85 may be directly connected to the sump 70 (e.g., a sump inlet 75), and the soft water discharged through the soft water outlet 85 may be directly supplied to the sump 70.

The case break 80 may include a drain inlet 86. The drain inlet 86 may be configured to allow water discharged from the washing chamber C to flow into the case break 80 after a washing process is completed. For example, the drain inlet 86 may be connected to the sump 70 (e.g., a sump drain 73), and the water discharged from the washing chamber C may be collected in the sump 70, drained therefrom, and enter the case break 80 through the drain inlet 86.

The case break 80 may include a drain outlet 87. The drain outlet 87 may be configured to allow water entering the case break 80 through the drain inlet 86 to be discharged. For example, the drain outlet 87 may be connected to the outside of the main body 10, and the water entering the case break 80 through the drain inlet 86 may be drained to the outside of the main body 10 through the drain outlet 87.

The case break 80 may be accommodated within the main body 10. For example, the case break 80 may be disposed between the tub 12 and the main body 10. For example, the case break 80 may be coupled to the side wall 12b of the tub 12. For example, the case break 80 may be coupled to an outer surface of the side wall 12b of the tub 12. While FIGS. 3 to 6 illustrate an embodiment in which the case break 80 is coupled to a left wall of the tub 12 disposed in a left direction (−Y direction), the position on the tub 12 to which the case break 80 is coupled may not be limited thereto.

The case break 80 may include a case body 81. The case body 81 may form an exterior of the case break 80. The case body 81 may form a flow path for water to flow therein. The case body 81 may form a reservoir space S in which water (e.g., soft water) is stored therein. The case body 81 may be coupled to the side wall 12b of the tub 12.

In an embodiment, the case body 81 may include a first case body 81a and a second case body 81b. The first case body 81a and the second case body 81b may be coupled to each other. A flow path through which water flows (e.g., an air break) may be formed between the first case body 81a and the second case body 81b. A reservoir space (e.g., the water tank 88) may be formed between the first case body 81a and the second case body 81b. In an example, the first case body 81a may be coupled to the side wall 12b of the tub 12, and the second case body 81b may be disposed between the main body 10 and the first case body 81a and coupled to the first case body 81a.

The raw water inlet 82, the raw water outlet 83, the soft water inlet 84, the drain inlet 86, and the drain outlet 87 described above may each be connected to an interior of the case body 81. The raw water inlet 82, the raw water outlet 83, the soft water inlet 84, the drain inlet 86, and the drain outlet 87 described above may each be connected to a space between the first case body 81a and the second case body 81b.

According to an embodiment, the case break 80 may include an air break configured to prevent washing water flowing along a flow path inside the case break 80 from flowing in reverse into the water treatment device 100. The air break may be formed as a flow path through which water flows inside the case body 81. The air break may be connected to at least a portion of the water source, the water treatment device 100, and the sump 70.

According to an embodiment, the case break 80 may include an air break hole configured to connect a flow path inside the case break 80 with the outside. The air break hole may allow pressure equalization between the inside and/or the internal flow path of the case break 80 and the atmosphere.

The air break may be configured to prevent backflow of washing water due to a siphon phenomenon in the event that water supply is interrupted.

The air break may be configured to cause water to flow toward the tub 12 when more than a predetermined hydraulic pressure or flow rate of water is introduced into the case break 80. According to an embodiment, the case break 80 may include a flowmeter. For example, the flowmeter may be disposed adjacent to the raw water inlet 82 and configured to detect a flow rate of raw water being supplied. The case break 80 may control the amount of water supply based on the flow rate of raw water detected by the flowmeter.

The case break 80 may include the water tank 88. The water tank 88 may include a reservoir space for storing washing water therein. The water tank 88 may store soft water treated by the water treatment device 100. The water tank 88 may be connected to a flow path through which washing water flows inside the case break 80. The water tank 88 may be connected to the air break. Soft water introduced into the case break 80 through the soft water inlet 84 may be supplied to the water tank 88 and stored in the water tank 88. For example, the water tank 88 may be connected to a flow path for soft water inside the case break 80 to flow at an upper portion of the case break 80.

The soft water outlet 85 described above may be connected to the water tank 88. The washing water stored in the water tank 88 may be discharged from the water tank 88 through the soft water outlet 85.

According to an embodiment, to adjust the amount of washing water supplied from the water tank 88 to the sump 70 and/or the water treatment device 100, the case break 80 may include a valve 89 configured to open or close the soft water outlet 85. The valve 89 may include various types of valves, such as a solenoid valve.

According to an embodiment, the case break 80 may be formed by integrating the water tank 88 with the flow path inside the case break 80 including the air break. However, the present disclosure is not limited thereto, and in various embodiments, the water tank 88 may be formed in a separate configuration separate from the case break 80, and in this case, the flow path inside the case break 80 and the water tank 88 may be connected to each other via a connecting member such as a hose, a pipe, or the like.

According to an embodiment, the sump 70 may include a collecting portion 71. In an example, the collecting portion 71 may collect washing water that has passed through the water treatment device 100 and the case break 80 in sequence. In an example, the collecting portion 71 may collect the washing water discharged from the water tank 88. In an example, the collecting portion 71 may collect the water discharged from the washing chamber C. The collecting portion 71 may include an opening to collect water. The collecting portion 71 may be provided on one side of the sump 70 facing the tub 12.

According to an embodiment, the sump 70 may include a seating portion 72. The bottom surface 12d of the tub 12 may be seated on the seating portion 72. The seating portion 72 may be coupled to the tub 12.

According to an embodiment, the sump 70 may include the sump drain 73. The sump drain 73 may be configured to drain the water collected in the collecting portion 71 (e.g., water discharged from the washing chamber C after the washing process is completed). The sump drain 73 may discharge water to the drain inlet 86 of the case break 80.

In an example, the sump drain 73 may be provided with a check valve. The check valve may reduce the backflow of water. For example, the check valve may be disposed at one end of the sump drain 73.

According to an embodiment, the sump 70 may include a drain pump coupling portion 74. The drain pump coupling portion 74 may be provided with a drain pump for pumping water to drain the collected water after the washing process.

According to an embodiment, the sump 70 may include the sump inlet 75. In an example, the sump inlet 75 may be connected to at least a portion of the sump connection port 118 or the soft water outlet 85 via a hose or the like. The washing water discharged from the case break 80 (e.g., the water tank 88) and/or the water treatment device 100 may flow to the sump 70 through the sump inlet 75. The water flowing to the sump 70 may be collected in the collecting portion 71.

In an example, the sump inlet 75 may be configured such that washing water that has passed through the water treatment device 100 and the case break 80 in turn is collected in the sump 70. In an example, the sump inlet 75 may be configured such that washing water that has passed through the water tank 88 in turn is collected in the sump 70.

In the following, an overall flow of water flowing along the case break 80, the water treatment device 100, and the sump 70 will be described as an example with reference to FIGS. 5 and 6.

Raw water supplied from various water sources provided outside the main body 10 or the like may be introduced into the case break 80 via the raw water inlet 82. The raw water entering through the raw water inlet 82 may pass through the case break 80, be discharged through the raw water outlet 83, and then be introduced into the water treatment device 100 through the inlet port 111. The raw water entering the water treatment device 100 may be treated through the water treatment device 100 to become soft water, and the treated soft water may be discharged from the water treatment device 100 through the outlet port 112. The soft water discharged through the outlet port 112 may be introduced back into the case break 80 through the soft water inlet 84. Soft water may flow along a flow path (e.g., the air break) inside the case break 80 and be introduced into and stored in the water tank 88. However, embodiments of the present disclosure are not limited thereto, and in various embodiments, the soft water discharged through the outlet port 112 may be directly introduced into the water tank 88 without passing through the flow path inside the case break 80. The soft water stored in the water tank 88 may be discharged through the soft water outlet 85 for delivery to the sump 70. The soft water discharged through the soft water outlet 85 may be introduced into the water treatment device 100 through the tank connection port 117, then discharged from the water treatment device 100 through the sump connection port 118, and supplied to the sump inlet 75. However, embodiments of the present disclosure are not limited thereto, and in various embodiments, the soft water discharged through the soft water outlet 85 may be directly supplied to the sump inlet 75 without passing through the water treatment device 100. The soft water supplied to the sump inlet 75 may be collected in the collecting portion 71 and supplied to the spraying device 40.

However, the connection relationship of the case break 80, the water treatment device 100, and the sump 70 described above is merely an example for describing embodiments of the present disclosure, and in various embodiments of the present disclosure, the case break 80, the water treatment device 100, and the sump 70 may be connected/coupled in various ways to supply or receive water from each other.

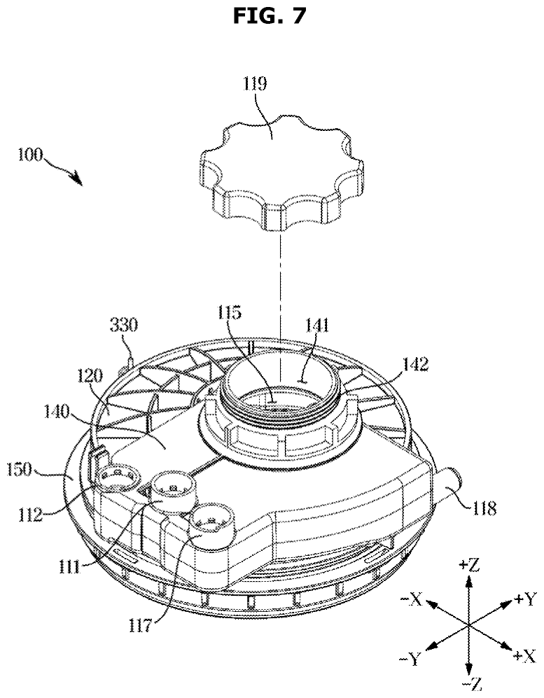

Hereinafter, the structure and operation of the water treatment device 100 according to various embodiments of the present disclosure will be described in more detail with reference to FIGS. 7 to 20.

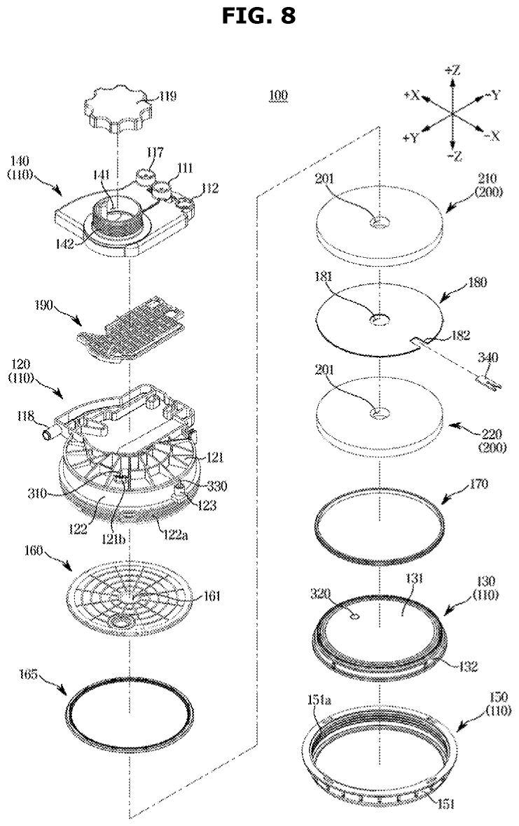

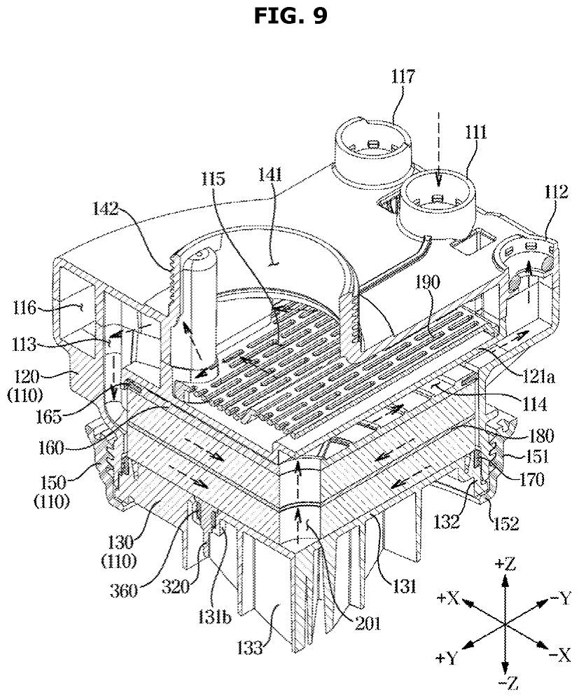

FIG. 7 is a perspective view illustrating the water treatment device of the dishwasher according to an embodiment of the present disclosure. FIG. 8 is an exploded perspective view illustrating the water treatment device of the dishwasher according to an embodiment of the present disclosure. FIG. 9 is a cross-sectional perspective view illustrating the water treatment device of the dishwasher according to an embodiment of the present disclosure.

Referring to FIGS. 7 to 9, the water treatment device 100 of the dishwasher 1 according to an embodiment of the present disclosure may be configured to treat washing water for supply to the sump 70. For example, the water treatment device 100 may be configured to soften water by adsorbing and removing ionic substances from the water passing through the water treatment device 100.

The water treatment device 100 may include the case 110. The case 110 may form an overall exterior of the water treatment device 100. Various configurations of the water treatment device 100, including a deionization electrode 200, may be accommodated within the case 110.

The case 110 may include the inlet port 111 described above. Water (e.g., raw water) may be introduced into the case 110 through the inlet port 111. In an example, the inlet port 111 may be disposed on the upper portion of the case 110. In an example, the inlet port 111 may be formed on an upper surface of the case 110. In an example, the inlet port 111 may have a shape that penetrates the upper surface of the case 110 in the vertical direction (Z-direction). In an example, water may pass through the inlet port 111 in the vertically downward direction (−Z direction) and flow into the interior of the case 110. However, embodiments of the present disclosure are not limited thereto, and the inlet port 111 may be formed at various positions on the case 110.

The case 110 may include outlet port 112 described above. Water (e.g., soft water) may be discharged to the outside of the case 110 through the outlet port 112. In an example, the outlet port 112 may be disposed on the upper portion of the case 110. The outlet port 112 may be formed on the upper surface of the case 110. In an example, the outlet port 112 may have a shape that penetrates the upper surface of the case 110 in the vertical direction (Z-direction). In an example, water may be discharged from the case 110 by passing through the outlet port 112 in the vertically upward direction (+Z direction). However, embodiments of the present disclosure are not limited thereto, and the outlet port 112 may be formed at various positions on the case 110.

A flow path extending between the inlet port 111 and the outlet port 112 may be formed inside the case 110. Raw water from the inlet port 111 may flow along the flow path inside the case 110 and be softened by removing ions, and the deionized soft water may be discharged through the outlet port 112. For example, an inflow path 113 through which water supplied through the inlet port 111 flows toward the deionization electrode 200, which will be described later, may be formed inside the case 110. The inflow path 113 may extend between the inlet port 111 and the deionization electrode 200. For example, an outflow path 114 through which water passing through the deionization electrode 200 flows toward the outlet port 112 may be formed inside the case 110. The outflow path 114 may extend between the deionization electrode 200 and the outlet port 112.

The case 110 may include the tank connection port 117 and the sump connection port 118 described above. Water supplied from the water tank 88 may be introduced into the case 110 through the tank connection port 117 and discharged from the case 110 through the sump connection port 118 to be supplied to the sump 70. A supply flow path 116 extending between the tank connection port 117 and the sump connection port 118 may be formed inside the case 110.

In an example, the tank connection port 117 may be formed on the upper portion of the case 110. In an example, the tank connection port 117 may be formed on the upper surface of the case 110. In an example, the tank connection port 117 may have a shape that penetrates the upper surface of the case 110 in the vertical direction (Z-direction). In an example, water may be introduced into the supply flow path 116 by passing through the tank connection port 117 in the vertically downward direction (−Z direction). In an example, the sump connection port 118 may be formed on the upper portion of the case 110. In an example, the sump connection port 118 may be disposed below the tank connection port 117 or at a substantially parallel position in the vertical direction (Z-direction). In an example, the sump connection port 118 may have a shape that penetrates the case 110 in the horizontal direction (e.g., left-to-right direction (Y)). In an example, water may be supplied to the sump 70 by passing through the sump connection port 118 in a rightward direction (+Y direction) and being discharged from the supply flow path 116. However, embodiments of the present disclosure are not limited thereto, and the tank connection port 117 and the sump connection port 118 may each be formed at various positions on the case 110.

A receiving portion 115 may be formed inside the case 110. The receiving portion 115 may be provided in the inflow path 113. The receiving portion 115 may be configured to receive a regeneration material for removing ions adsorbed on the deionization electrode 200.

In an example, the case 110 may include a supply opening 141. The supply opening 141 may be configured to connect the receiving portion 115 to the outside of the case 110. In an example, the supply opening 141 may connect the receiving portion 115 and the outside of the case 110 at an upper side of the receiving portion 115. In an example, the receiving portion 115 may be open in an upward direction (+Z direction). A regeneration material may be input into the receiving portion 115 via the supply opening 141.

In an example, the water treatment device 100 may include a cap 119 configured to open or close the supply opening 141. The case 110 may include a cap coupling portion 142, and the cap 119 may be detachably coupled to the cap coupling portion 142. The supply opening 141 may be closed when the cap 119 is coupled to the cap coupling portion 142, and the supply opening 141 may be open when the cap 119 is detached from the cap coupling portion 142. In an example, when the cap 119 is coupled to the cap coupling portion 142, the cap 119 may be positioned inside the tub 12 (e.g., in a lower portion of the washing chamber C).

According to an embodiment, the water treatment device 100 may include a filter 190 provided in the inflow path 113. The filter 190 may be disposed in the flow path between the inlet port 111 and the deionization electrode 200. The filter 190 may be configured to filter out foreign matter from the raw water introduced through the inlet port 111. In an example, the filter 190 may be disposed in the receiving portion 115.

The water treatment device 100 may include the deionization electrode 200. The deionization electrode 200 may be disposed inside the case 110. The deionization electrode 200 may be disposed in a flow path inside the case 110 extending from the inlet port 111 toward the outlet port 112.

The deionization electrode 200 may be configured to allow water to pass therethrough. Water flowing into the case 110 through the inlet port 111 may flow through the deionization electrode 200 and toward the outlet port 112.

The deionization electrode 200 may be configured to remove ions from the water passing through the deionization electrode 200. The deionization electrode 200 may be configured to adsorb ionic substances from the water flowing into the case 110 through the inlet port 111. The deionization electrode 200 may adsorb ionic substances from the water passing through the deionization electrode 200 when a voltage is applied. Water from which ionic substances is removed by the deionization electrode 200 may become soft water and flow to the outlet port 112.

According to an embodiment, water flowing along the inflow path 113 may flow into a circumferential surface of the deionization electrode 200. At least a portion of the circumferential surface of the deionization electrode 200 may face one end of the inflow path 113 adjacent to the deionization electrode 200. Water flowing into the circumferential surface of the deionization electrode 200 may be treated and softened as it passes through the deionization electrode 200.

According to an embodiment, the deionization electrode 200 may include a hollow 201. The hollow 201 of the deionization electrode 200 may be connected to the outflow path 114. Water that passes through the deionization electrode 200 after entering the circumferential surface of the deionization electrode 200 may be discharged through the hollow 201 and flow toward the outflow path 114.

The hollow 201 may be disposed at a substantial center of the deionization electrode 200. In an example, the hollow 201 may be disposed to pass through the center of the deionization electrode 200 substantially in the first direction (Z-direction). In an example, the hollow 201 may extend in the substantially first direction (Z-direction). Water discharged from the deionization electrode 200 through the hollow 201 may flow in the first direction (Z-direction) and move to the outflow path 114. In an example, water discharged from the deionization electrode 200 through the hollow 201 may flow in the upward direction (+Z direction) and move to the outflow path 114. The water moved to the outflow path 114 may flow along the outflow path 114 and be discharged from the case 110.

In an example, the deionization electrode 200 may have a cylinder shape with the substantial hollow 201.

The deionization electrode 200 may include a conductive material. For example, the deionization electrode 200 may include a plurality of electrode layers including a conductive material, and the plurality of electrode layers may be stacked on top of each other. The plurality of electrode layers included in the deionization electrode 200 may be stacked in the first direction (Z-direction). For example, the plurality of electrode layers included in the deionization electrode 200 may be stacked in the substantially vertical direction (Z-direction). The deionization electrode 200 may include a capacitive deionization (CDI) electrode formed by stacking a plurality of electrode layers.

In an example, the plurality of electrode layers included in the deionization electrode 200 may include a porous carbon electrode, such as graphite. However, embodiments of the present disclosure are not limited thereto, and the deionization electrode 200 may include various conductive materials.

Dielectric polarization may occur in each of the plurality of electrode layers included in the deionization electrode 200 when a voltage is applied. Water flowing inside the case 110 may pass between the plurality of electrode layers, and the dielectrically polarized plurality of electrode layers may adsorb ionic substances from the water passing therethrough.

According to an embodiment, the deionization electrode 200 may include a plurality of deionization electrodes 210 and 220. The plurality of deionization electrodes 210 and 220 may be stacked on top of each other. For example, the plurality of deionization electrodes 210 and 220 may be arranged in the first direction (Z-direction). For example, the plurality of deionization electrodes 210 and 220 may be stacked in the first direction (Z-direction).

The plurality of deionization electrodes 200 may include a first deionization electrode 210 and a second deionization electrode 220. In an example, the first deionization electrode 210 may be disposed above the second deionization electrode 220. A voltage may be applied to each of the first deionization electrode 210 and the second deionization electrode 220, and each may soften water based on the applied voltage. The first deionization electrode 210 and the second deionization electrode 220 may have a shape corresponding to each other. The first deionization electrode 210 and the second deionization electrode 220 may each have the hollow 201.

While FIGS. 8 and 9 illustrates an embodiment in which the deionization electrodes 200 are provided in two, the number of deionization electrodes 200 in the embodiment of the present disclosure is not limited thereto. In various embodiments, the deionization electrode 200 may include three or more deionization electrodes arranged in the first direction (Z-direction) as well as two deionization electrodes 210 and 220. In various embodiments, the deionization electrode 200 may be provided in a single unit. Meanwhile, that the deionization electrode 200 is single here is not limited to the meaning that the deionization electrode 200 is configured as a single layer, and a single deionization electrode 200 may include a plurality of electrode layers stacked as described later.

According to an embodiment of the present disclosure, the dishwasher 1 may include terminals 310, 320, 330 and 340. The terminals 310, 320, 330 and 340 may be configured to apply a voltage to the deionization electrode 200. The terminals 310, 320, 330 and 340 may be electrically connected to the deionization electrode 200. The terminals 310, 320, 330 and 340 may be connected to an external power source or a separate power supply provided in the dishwasher 1, and the deionization electrode 200 may receive a voltage applied through the terminals 310, 320, 330 and 340. The terminals 310, 320, 330 and 340 may each include a conductive material.

A detailed description of steps by which the deionization electrode 200 is applied a voltage to adsorb ionic substances from water, and the structure and operation of the terminals 310, 320, 330 and 340 for applying a voltage to the deionization electrode 200 will be described later.

Hereinafter, a detailed structure of the water treatment device 100 according to an embodiment will be described in more detail by way of example.

According to an embodiment, the case 110 of the water treatment device 100 may include a first case 120. The first case 120 may cover a portion of the deionization electrode 200.

The first case 120 may include a first horizontal cover portion 121 that covers one surface of the deionization electrode 200. The first horizontal cover portion 121 may cover one surface extending in the horizontal direction of the deionization electrode 200. The first horizontal cover portion 121 may cover one flat surface of the deionization electrode 200. For example, the first horizontal cover portion 121 may cover an upper surface of the deionization electrode 200. The first horizontal cover portion 121 may form an upper surface of the first case 120.

The first case 120 may include a circumferential cover portion 122 that covers a circumferential surface of the deionization electrode 200. For example, the circumferential cover portion 122 may extend from a rim of the first horizontal cover portion 121. For example, the circumferential cover portion 122 may extend in the downward direction (−Z direction) from the first horizontal cover portion 121. The circumferential cover portion 122 may form a circumferential surface of the first case 120.

The first case 120 may include a terminal accommodating portion 123 protruding outwardly from the circumferential cover portion 122. The terminal accommodating portion 123 may protrude from the circumferential cover portion 122 in the second direction (X-direction) different from the first direction (Z-direction). In an example, the terminal accommodating portion 123 may protrude in a rearward direction (−X direction) from the circumferential cover portion 122.

In an example, the inlet port 111 may be connected to the first case 120. In an example, the outlet port 112 may be connected to the first case 120. In an example, the tank connection port 117 may be connected to the first case 120. In an example, the sump connection port 118 may be included in the first case 120.

According to an embodiment, the case 110 may include a second case 130. The second case 130 may cover a portion of the deionization electrode 200. The second case 130 may cover a portion of the deionization electrode 200 that is different from the portion of the deionization electrode 200 covered by the first case 120.

The second case 130 may include a second horizontal cover portion 131 that covers one surface of the deionization electrode 200. The second horizontal cover portion 131 may cover one surface extending in the horizontal direction of the deionization electrode 200. The second horizontal cover portion 131 may cover one flat surface of the deionization electrode 200. For example, the second horizontal cover portion 131 may cover a lower surface of the deionization electrode 200. In an example, the second horizontal cover portion 131 may contact the deionization electrode 200. The second horizontal cover portion 131 may form an upper surface of the second case 130. In an example, the second horizontal cover portion 131 may be disposed opposite the first horizontal cover portion 121.

The second case 130 may include a circumferential wall 132. For example, the circumferential wall 132 may extend from a rim of the second horizontal cover portion 131. For example, the circumferential wall 132 may extend in the downward direction (−Z direction) from the second horizontal cover portion 131. The circumferential wall 132 may form a circumferential surface of the second case 130.

According to an embodiment, the circumferential cover portion 122 of the first case 120 and the circumferential wall 132 of the second case 130 may contact each other. For example, an inner surface of the circumferential cover portion 122 and an outer surface of the circumferential wall 132 may contact each other.

The second case 130 may include a plurality of ribs 133 protruding from the second horizontal cover portion 131. The plurality of ribs 133 may be configured to increase the rigidity of the second case 130. For example, the plurality of ribs 133 may protrude in an outward direction of the second case 130 from the second horizontal cover portion 131. For example, the plurality of ribs 133 may protrude in the downward direction (−Z direction) from the second horizontal cover portion 131.

The deionization electrode 200 may be disposed between the first case 120 and the second case 130. A receiving space for the deionization electrode 200 may be formed between the first case 120 and the second case 130. At least a portion of a washing water flow path flowing from the inlet port 111 toward the outlet port 112 may be formed between the first case 120 and the second case 130.

According to an embodiment, the second case 130 may be disposed below the first case 120.

The first case 120 and the second case 130 may be coupled to each other. The first case 120 and the second case 130 may be coupled to each other to form a receiving space for the deionization electrode 200 and at least a portion of a washing water flow path. According to an embodiment, the second case 130 may be coupled to a lower portion of the first case 120.

In contrast to the embodiment described above, in various embodiments, the first case 120 may include the first horizontal cover portion 121 but may not include the circumferential cover portion 122. In such an embodiment, the second case 130 may include the second horizontal cover portion 131 and a circumferential cover portion extending in the upward direction (+Z direction) from the second horizontal cover portion 131 to cover the circumferential surface of the deionization electrode 200.

According to an embodiment, the case 110 may include a cover case 140. The cover case 140 may cover the first case 120. The cover case 140 may cover the first case 120 in the first direction (Z-direction). For example, the cover case 140 may cover the first case 120 from above. The cover case 140 may form the upper surface of the case 110.

The cover case 140 may be coupled to the first case 120. For example, the cover case 140 may be coupled to the first case 120 by various methods, such as thermal fusion, screw fastening, or the like.

The receiving portion 115 may be formed between the first case 120 and the cover case 140. The first case 120 and the cover case 140 may be coupled to each other to form the receiving portion 115. The supply opening 141 connected to the receiving portion 115 may be formed in the cover case 140. The cap coupling portion 142 arranged to be coupled with the cap 119 for opening or closing the supply opening 141 may be provided on the cover case 140.

The filter 190 may be disposed in the receiving portion 115 formed between the first case 120 and the cover case 140. For example, the filter 190 may be seated on the upper surface of the first case 120 and may be covered by the cover case 140.

At least a portion of the inflow path 113 may be formed between the first case 120 and the cover case 140. The first case 120 and the cover case 140 may be coupled to each other to form at least a portion of the inflow path 113.

In an example, the inlet port 111 may be included in the cover case 140. In an example, the inlet port 111 may be formed on an upper surface of the cover case 140.

In an example, the outlet port 112 may be included in the cover case 140. In an example, the outlet port 112 may be formed on the upper surface of the cover case 140.

At least a portion of the supply flow path 116 may be formed between the first case 120 and the cover case 140. The first case 120 and the cover case 140 may be coupled to each other to form at least a portion of the supply flow path 116.

In an example, the tank connection port 117 may be included in the cover case 140. In an example, the tank connection port 117 may be formed on the upper surface of the cover case 140.

According to an embodiment, the case 110 may include a coupling case 150. The coupling case 150 may be configured to couple the first case 120 and the second case 130. The coupling case 150 may detachably couple the first case 120 and the second case 130.

According to an embodiment, the coupling case 150 may be movable relative to the first case 120 when coupling the first case 120 and the second case 130. The coupling case 150 may be configured to press the second case 130 toward the first case 120 when coupling the first case 120 and the second case 130. A relative position of the second case 130 relative to the first case 120 may vary depending on the extent to which the coupling case 150 presses the second case 130. For example, a position of the second case 130 in the first direction (Z-direction) relative to the first case 120 may vary depending on the extent to which the coupling case 150 presses the second case 130.

According to an embodiment, the coupling case 150 may have a substantially ring shape.

The coupling case 150 may include a case coupling portion 151. The case coupling portion 151 may be coupled to the first case 120. For example, the case coupling portion 151 may be coupled to the circumferential cover portion 122 of the first case 120. The case coupling portion 151 may form a circumferential surface of the coupling case 150.

The case coupling portion 151 may be movably coupled to the first case 120. The case coupling portion 151 may be movably coupled to the circumferential cover portion 122. For example, a first thread 122a may be formed on an outer surface of the circumferential cover portion 122, and a second thread 151a configured to engage with the first thread 122a may be formed on an inner surface of the case coupling portion 151. The case coupling portion 151 may be coupled to the circumferential cover portion 122 in response to the first thread 122a and the second thread 151a engaging with each other. By adjusting the degree of engagement between the first thread 122a and the second thread 151a, the case coupling portion 151 may be movable relative to the circumferential cover portion 122.

The coupling case 150 may include a support 152. The support 152 may be configured to support the second case 130. For example, the support 152 may be configured to support the second case 130 in the first direction (Z-direction). The support 152 may contact one side of the second case 130. For example, the support 152 may contact a lower side of the second case 130. For example, the support 152 may contact a lower end of the circumferential wall 132.

In an example, the support 152 may extend inwardly from the case coupling portion 151. In an example, the support 152 may extend inwardly from a lower end of the case coupling portion 151 to contact the second case 130.

As the coupling case 150 moves relative to the first case 120, the extent to which the support 152 presses the second case 130 may vary.

In the event that the degree of coupling of the coupling case 150 with the first case 120 increases (e.g., the degree of engagement of the first thread 122a with the second thread 151a increases), the coupling case 150 may move to be closer to the first case 120 in the first direction (Z) (e.g., the coupling case 150 may move upward (+Z direction)), and in this case, the degree to which the support 152 presses the second case 130 toward the first case 120 in the first direction (Z-direction) (e.g., upward (+Z direction)) may increase, so that the second case 130 may move toward the first case 120 in the first direction (Z-direction) (e.g., upward (+Z direction)). In this case, the degree of coupling between the first case 120 and the second case 130 may increase.

In the event that the degree of coupling of the coupling case 150 with the first case 120 decreases (e.g., the degree of engagement of the first thread 122a with the second thread 151a decreases), the coupling case 150 may move away from the first case 120 in the first direction (Z) (e.g., the coupling case 150 may move downward (−Z direction)), and in this case, the degree to which the support 152 presses the second case 130 toward the first case 120 may increase, so that the second case 130 may move away from the first case 120 in the first direction (Z-direction) (e.g., downward (−Z direction)). In this case, the degree of coupling between the first case 120 and the second case 130 may decrease.

As such, the degree of coupling and the relative position between the first case 120 and the second case 130 may be adjusted using the coupling case 150, and the degree to which the deionization electrode 200 is pressed and/or compressed between the first case 120 and the second case 130 may be adjusted. As a result, the deionization electrode 200 may be reliably contacted by terminals (e.g., a first terminal 310 and a second terminal 320) mounted on the first case 120 and the second case 130.

The structures of the case 110 described above are merely an embodiment, and embodiments of the present disclosure are not limited thereto.

According to an embodiment, the water treatment device 100 may include a case seal 170. The case seal 170 may be disposed between the first case 120 and the second case 130. For example, the case seal 170 may be disposed between the circumferential cover portion 122 of the first case 120 and the circumferential wall 132 of the second case 130. The case seal 170 may be configured to cover a gap between the circumferential cover portion 122 and the circumferential wall 132 to prevent leakage of washing water inside the case 110.

For example, the case seal 170 may contact the inner surface of the circumferential cover portion 122. For example, the case seal 170 may contact the outer surface of the circumferential wall 132.

For example, the case seal 170 may have a substantially ring shape. The case seal 170 may have a ring shape with a central axis extending in the first direction (Z-direction).

The case seal 170 may be configured to be elastically deformable. For example, the case seal 170 may include various elastic materials such as rubber, elastic resin, and the like. Even though the degree of coupling or relative position between the first case 120 and the second case 130 varies by the coupling case 150, leakage through the gap between the first case 120 and the second case 130 may be more effectively prevented as the elastically deformable case seal 170 covers the gap.

The terminals 310, 320, and 330 may be coupled to the case 110.

For example, the first terminal 310, which will be described later, may be coupled to the first case 120. The first case 120 may include a first terminal coupling portion 121b configured to be coupled with the first terminal 310. In an example, the first terminal coupling portion 121b may be disposed on the first horizontal cover portion 121.

The first terminal 310 may penetrate the first terminal coupling portion 121b. In an example, the first terminal 310 may penetrate the first terminal coupling portion 121b in the first direction (Z-direction). The first terminal 310 may be coupled to the first case 120 by penetrating the first terminal coupling portion 121b and may contact the deionization electrode 200 (e.g., the first deionization electrode 210) disposed inside the case 110.

According to an embodiment, a first terminal seal surrounding the first terminal 310 may be disposed between a portion of the first terminal 310 penetrating the first terminal coupling portion 121b and the first terminal coupling portion 121b. The first terminal seal may be elastically deformable. For example, the first terminal seal may include an elastic material, such as rubber.

For example, the second terminal 320, which will be described later, may be coupled to the second case 130. The second case 130 may include a second terminal coupling portion 131b configured to be coupled with the second terminal 320. In an example, the second terminal coupling portion 131b may be disposed on the second horizontal cover portion 131.

The second terminal 320 may penetrate the second terminal coupling portion 131b. In an example, the second terminal 320 may penetrate the second terminal coupling portion 131b in the first direction (Z-direction). The second terminal 320 may be coupled to the second case 130 by penetrating the second terminal coupling portion 131b and may contact the deionization electrode 200 (e.g., the second deionization electrode 220) disposed inside the case 110.

According to an embodiment, a second terminal seal 360 surrounding the second terminal 320 may be disposed between a portion of the second terminal 320 penetrating the second terminal coupling portion 131b and the second terminal coupling portion 131b. The second terminal seal 360 may be elastically deformable. For example, the second terminal seal 360 may include an elastic material, such as rubber.

For example, a pin terminal 330, which will be described later, may be coupled to the first case 120. The first case 120 may include the terminal accommodating portion 123 configured to receive at least a portion of the pin terminal 330. The pin terminal 330 may be coupled to the terminal accommodating portion 123.

The pin terminal 330 may be inserted into the terminal accommodating portion 123. In an example, the pin terminal 330 may be inserted into the terminal accommodating portion 123 in the first direction (Z-direction). The pin terminal 330 may be coupled to the first case 120 by being inserted into the terminal accommodating portion 123 and may be connected to a contact terminal 340 disposed inside the case 110.

According to an embodiment, the water treatment device 100 may include a flow path partition 160. The flow path partition 160 may be configured to partition the inflow path 113 and the outflow path 114. The flow path partition 160 may prevent raw water and soft water from mixing.

The flow path partition 160 may be disposed between the deionization electrode 200 and the first case 120. The flow path partition 160 may be arranged in the first direction (Z-direction) with the deionization electrode 200 and the first horizontal cover portion 121 of the first case 120. For example, the flow path partition 160 may be disposed below (−Z direction) the first horizontal cover portion 121. For example, the flow path partition 160 may be disposed above (+Z direction) the deionization electrode 200.

The flow path partition 160 may be in contact with the first case 120. For example, the flow path partition 160 may be in contact with an inner surface of the first horizontal cover portion 121.

The flow path partition 160 may be in contact with the deionization electrode 200. For example, the flow path partition 160 may be in contact with a flat one surface (e.g., an upper surface) of the first deionization electrode 210.

In an example, the flow path partition 160 may have a substantially flat disk shape, but the shape thereof is not limited thereto.

The flow path partition 160 may form at least a portion of the outflow path 114 between the flow path partition 160 and the first case 120. The flow path partition 160 may face the inner surface of the first horizontal cover portion 121, and at least a portion of the outflow path 114 may be formed between the flow path partition 160 and the first horizontal cover portion 121. The outflow path 114 may be disposed above (+Z direction) the flow path partition 160. For example, the first horizontal cover portion 121 may include an outflow path groove 121a having a shape recessed upwardly (+Z direction) from the inner surface. The outflow path 114 may be formed between the flow path partition 160 and the outflow path groove 121a. The outflow path groove 121a may be connected to the outlet port 112.

The flow path partition 160 may include a flow path partition hole 161 configured to allow water to pass therethrough. The flow path partition hole 161 may be positioned correspondingly to the hollow 201 of the deionization electrode 200. The flow path partition hole 161 may abut the hollow 201 of the deionization electrode 200. A portion of a flow path through which water flows may be formed in response to the hollow 201 of the deionization electrode 200 and the flow path partition hole 161 being connected to each other. The flow path partition hole 161 may be configured to allow soft water treated by passing through the deionization electrode 200 to pass therethrough.

The first terminal 310 may penetrate the flow path partition 160. The first terminal 310 may penetrate the first case 120 and the flow path partition 160 in the first direction (Z-direction) to abut the first deionization electrode 210.

According to an embodiment, the water treatment device 100 may include a flow path partition seal 165. The flow path partition seal 165 may be disposed between the flow path partition 160 and the first case 120. The flow path partition seal 165 may be disposed between a circumference of the flow path partition 160 and an inner wall of the circumferential cover portion 122 of the first case 120. In an example, the flow path partition seal 165 may be coupled to the circumference of the flow path partition 160. The flow path partition seal 165 may cover a gap between the flow path partition 160 and the circumferential cover portion 122 to partition the inflow path 113 and the outflow path 114.

In an example, the flow path partition seal 165 may have a substantially ring shape.

The flow path partition seal 165 may be configured to be elastically deformable. For example, the flow path partition seal 165 may include various elastic materials, such as rubber, elastic resin, and the like.

According to an embodiment, the water treatment device 100 may include an electrode partition 180. The electrode partition 180 may be disposed between the first deionization electrode 210 and the second deionization electrode 220. The first deionization electrode 210, the electrode partition 180, and the second deionization electrode 220 may be sequentially disposed in the first direction (Z-direction). The electrode partition 180 may be in contact with the first deionization electrode 210 and the second deionization electrode 220, respectively. The electrode partition 180 may be in contact with a lower surface of the first deionization electrode 210 and may be in contact with an upper surface of the second deionization electrode 220.

The electrode partition 180 may electrically insulate the first deionization electrode 210 and the second deionization electrode 220. The electrode partition 180 may include a variety of insulating materials.

In an example, the electrode partition 180 may have a substantially flat disk shape, but the shape thereof is not limited thereto.

The electrode partition 180 may include an electrode partition hole 181 configured to allow water to pass therethrough. The electrode partition hole 181 may be connected to the hollow 201 of the deionization electrode 200. The electrode partition hole 181 may be configured to allow soft water treated by passing through the deionization electrode 200 to pass therethrough.

The electrode partition 180 may include a terminal groove 182 in which a portion of a contact terminal 340, which will be described later, provided to be disposed. A portion of the contact terminal 340 may be inserted into the terminal groove 182 of the electrode partition 180. For example, a portion of the contact terminal 340 may be inserted into the terminal groove 182 of the electrode partition 180 in the second direction (X-direction). A portion of the contact terminal 340 may penetrate the terminal groove 182 of the electrode partition 180. For example, a portion of the contact terminal 340 may penetrate the terminal groove 182 of the electrode partition 180 in the first direction (Z-direction). The terminal groove 182 may have a shape recessed inwardly from a rim of the electrode partition 180.

Referring to FIG. 9, the process by which water is treated as it passes through the water treatment device 100 according to the structure described above will be described.

Referring to FIG. 9, raw water from a water source may be introduced into the case 110 through the inlet port 111. The raw water introduced into the case 110 may pass through the receiving portion 115. The raw water introduced into the case 110 may flow through the filter 190 and toward the deionization electrode 200 along the inflow path 113. The raw water flowing along the inflow path 113 may be introduced into the deionization electrode 200 through the circumferential surface of the deionization electrode 200, be softened while passing through the deionization electrode 200 in an inward direction, and then be discharged through the hollow 201. The soft water discharged through the hollow 201 may flow to the outflow path 114 between the first case 120 and the flow path partition 160. For example, soft water passing through the first deionization electrode 210 may flow sequentially through the hollow 201 of the first deionization electrode 210 and the flow path partition hole 161 into the outflow path 114, and the soft water passing through the second deionization electrode 220 may flow sequentially through the hollow 201 of the second deionization electrode 220, the electrode partition hole 181, the hollow 201 of the first deionization electrode 210, and the flow path partition hole 161 into the outflow path 114. The soft water introduced into the outflow path 114 may flow along the outflow path 114 to the outlet port 112, and may be discharged to the outside of the case 110 through the outlet port 112.

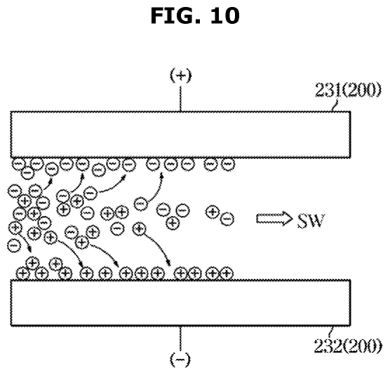

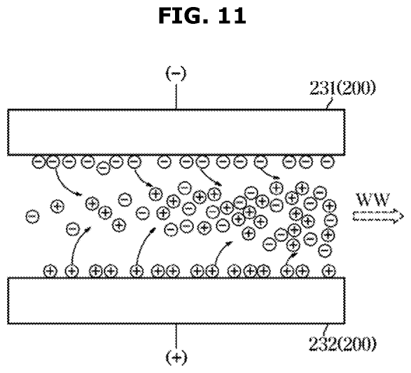

FIG. 10 is a schematic view illustrating a process of softening water by the water treatment device of the dishwasher according to an embodiment of the present disclosure. FIG. 11 is a schematic view illustrating a process of removing scale from the water treatment device of the dishwasher according to an embodiment of the present disclosure.

With reference to FIGS. 10 and 11, a process of softening water by the deionization electrode 200 included in the water treatment device 100 according to an embodiment of the present disclosure and an operation of regenerating the deionization electrode 200 will be described.

According to an embodiment, the deionization electrode 200 may include a plurality of electrode layers 231 and 232. In an example, the plurality of electrode layers 231 and 232 may be stacked in the first direction (Z-direction). When a voltage is applied to the deionization electrode 200, an electric field may be generated between a pair of adjacent electrode layers (e.g., a first electrode layer 231 and a second electrode layer 232) of the plurality of electrode layers 231 and 232.

Referring to FIG. 10, as a first voltage (adsorption voltage) for adsorbing ionic substances from water is applied to the deionization electrode 200, an electric field may be generated between the first electrode layer 231 and the second electrode layer 232. In an example, one side of the first electrode layer 231 may act as an anode, and one side of the second electrode layer 232 may act as a cathode. In this case, when water is moved between the first electrode layer 231 and the second electrode layer 232, which are spaced apart from each other, ionic substances contained in the water may be moved to the first electrode layer 231 and the second electrode layer 232 due to an electric attraction force by the electric field. For example, ionic substances with a negative charge may migrate to the first electrode layer 231 and be adsorbed, and ionic substances with a positive charge may migrate to the second electrode layer 232 and be adsorbed. Through such a process, the water passing through the deionization electrode 200 may be discharged as soft water (SW) that contains no ionic substances or a very low amount of ionic substances.

As ionic substances continue to accumulate on the first electrode layer 231 and the second electrode layer 232 over a continuous water treatment process, the electric field formed between the first electrode layer 231 and the second electrode layer 232 may weaken, thereby reducing the ion adsorption capability of the deionization electrode 200. To restore the ion adsorption capability of the deionization electrode 200, a regeneration process or a scale removal process may be performed.

As described above, when a regeneration process of the water treatment device 100 is to be performed, a regeneration material for removing scale from the deionization electrode 200 may be input into the receiving portion 115. For example, a user may access the cap 119 through the interior of the tub 12, release the cap 119 from the cap coupling portion 142 to open the supply opening 141, and then input the regeneration material into the receiving portion 115 through the supply opening 141. For example, the regeneration material may include an acidic solution for removing scale from the deionization electrode 200. For example, the acidic solution may include a citric acid solution.

Referring to FIG. 11, to restore the ion adsorption capability of the deionization electrode 200, a second voltage (regeneration voltage) opposite to the first voltage applied for the water treatment process may be applied to the deionization electrode 200. When the second voltage is applied to the deionization electrode 200, an electric field in a direction opposite to that during the water treatment process may be generated between the first electrode layer 231 and the second electrode layer 232. In an example, one side of the first electrode layer 231 may act as a negative electrode, and one side of the second electrode layer 232 may act as a positive electrode. Accordingly, the ionic substances attached to the first electrode layer 231 and the second electrode layer 232 may be separated from the first electrode layer 231 and the second electrode layer 232. Through such a process, the ionic substances removed from the deionization electrode 200 may be discharged as wastewater (WW) along with water.

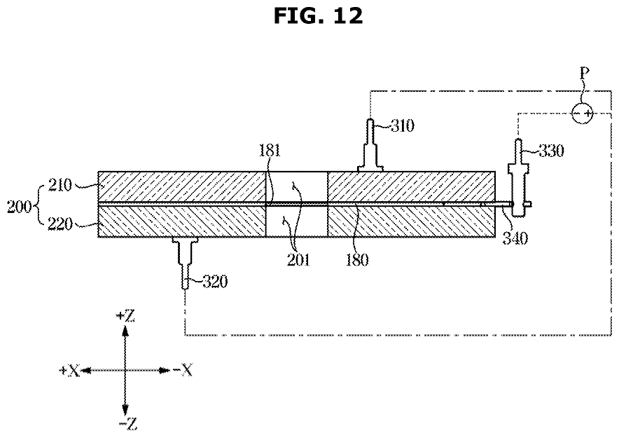

FIG. 12 is a view illustrating various configurations, such as a deionization electrode and a plurality of terminals included in the water treatment device of the dishwasher according to an embodiment of the present disclosure.

Referring to FIG. 12, the water treatment device 100 of the dishwasher 1 according to an embodiment of the present disclosure may include the plurality of deionization electrodes 200. The water treatment device 100 may include the first deionization electrode 210 and the second deionization electrode 220. In an example, the first deionization electrode 210 and the second deionization electrode 220 may be arranged in the first direction (Z-direction) relative to each other.

The plurality of deionization electrodes 200 may be electrically insulated from each other. For example, the first deionization electrode 210 and the second deionization electrode 220 may be electrically insulated from each other by the electrode partition 180. A voltage may be applied to each of the first deionization electrode 210 and the second deionization electrode 220. The first deionization electrode 210 and the second deionization electrode 220 may be included in separate electric circuits.

Each of the plurality of deionization electrodes 200 may be electrically connected to a power source P via the terminals 310, 320, 330 and 340. Each of the plurality of deionization electrodes 200 may receive a voltage from the power source P via the terminals 310, 320, 330 and 340. The power source P may be a power source disposed outside the case 110.

The water treatment device 100 may include the first terminal 310. The first terminal 310 may be electrically connected to the first deionization electrode 210. The first terminal 310 may be configured to electrically connect the first deionization electrode 210 to the power source P. The first terminal 310 may be connected to one side of the first deionization electrode 210. For example, the first terminal 310 may contact the first deionization electrode 210 in the first direction (Z-direction). For example, the first terminal 310 may contact one side of the first deionization electrode 210 opposite to the second deionization electrode 220. For example, the first terminal 310 may contact one side of the first deionization electrode 210 extending in the horizontal direction. For example, the first terminal 310 may contact one flat surface of the first deionization electrode 210. For example, the first terminal 310 may contact an upper surface of the first deionization electrode 210.

In an example, the first terminal 310 may penetrate the first case 120 and the flow path partition 160 to contact the first deionization electrode 210. In an example, the first terminal 310 may penetrate the first horizontal cover portion 121 and the flow path partition 160 to contact the first deionization electrode 210.

The water treatment device 100 may include the second terminal 320. The second terminal 320 may be electrically connected to the second deionization electrode 220. The second terminal 320 may be configured to electrically connect the second deionization electrode 220 to the power source P. The second terminal 320 may be connected to one side of the second deionization electrode 220. For example, the second terminal 320 may contact the second deionization electrode 220 in the first direction (Z-direction). For example, the second terminal 320 may contact one side of the second deionization electrode 220 opposite to the first deionization electrode 210. For example, the second terminal 320 may contact one side of the second deionization electrode 220 extending in the horizontal direction. For example, the second terminal 320 may contact one flat surface of the second deionization electrode 220. For example, the second terminal 320 may contact a lower surface of the second deionization electrode 220.

In an example, the second terminal 320 may penetrate the second case 130 to contact the second deionization electrode 220. In an example, the second terminal 320 may penetrate the second horizontal cover portion 131 to contact the second deionization electrode 220.

The water treatment device 100 may include the pin terminal 330 and the contact terminal 340. The pin terminal 330 and the contact terminal 340 may be electrically connected to each other. The pin terminal 330 may be electrically connected to the power source P. The pin terminal 330 may electrically connect the contact terminal 340 to the power source P. The pin terminal 330 and the contact terminal 340 may be electrically connected to the deionization electrode 200. The pin terminal 330 and the contact terminal 340 may electrically connect the deionization electrode 200 to the power source P.

The pin terminal 330 and the contact terminal 340 may be configured to electrically connect the first deionization electrode 210 to the power source P. The contact terminal 340 may be electrically connected to the first deionization electrode 210. The contact terminal 340 may contact the first deionization electrode 210. For example, the contact terminal 340 may contact the first deionization electrode 210 in the first direction (Z-direction). For example, the contact terminal 340 may contact one side of the first deionization electrode 210 adjacent to the second deionization electrode 220. For example, the contact terminal 340 may contact one side of the first deionization electrode 210 extending in the horizontal direction. For example, the contact terminal 340 may contact one flat surface of the first deionization electrode 210. For example, the contact terminal 340 may contact a lower surface of the first deionization electrode 210. A portion of the lower surface of the first deionization electrode 210 may contact the electrode partition 180, and another portion may contact the contact terminal 340.

The pin terminal 330 and the contact terminal 340 may be configured to electrically connect the second deionization electrode 220 to the power source P. The contact terminal 340 may be electrically connected to the second deionization electrode 220. The contact terminal 340 may contact the second deionization electrode 220. For example, the contact terminal 340 may contact the second deionization electrode 220 in the first direction (Z-direction). For example, the contact terminal 340 may contact one side of the second deionization electrode 220 adjacent to the first deionization electrode 210. For example, the contact terminal 340 may contact one side of the second deionization electrode 220 extending in the horizontal direction. For example, the contact terminal 340 may contact one flat surface of the second deionization electrode 220. For example, the contact terminal 340 may contact the upper surface of the second deionization electrode 220. A portion of the upper surface of the second deionization electrode 220 may contact the electrode partition 180, and another portion may contact the contact terminal 340.

The contact terminal 340 may be disposed between the first deionization electrode 210 and the second deionization electrode 220. The contact terminal 340 may be referred to by a term such as ‘intermediate terminal’.

With such a structure, the power source P, the first terminal 310, the first deionization electrode 210, the contact terminal 340, and the pin terminal 330 may constitute one electric circuit, and the power source P, the second terminal 320, the second deionization electrode 220, the contact terminal 340, and the pin terminal 330 may constitute another electric circuit.

In an example, the first terminal 310 and the second terminal 320 may connect the deionization electrode 200 to a positive electrode of the power source P, and the contact terminal 340 and the pin terminal 330 may connect the deionization electrode 200 to a negative electrode of the power source P, but embodiments of the present disclosure are not limited thereto.

As such, by applying a voltage to the first deionization electrode 210 using the first terminal 310, the pin terminal 330, and the contact terminal 340, and applying a separate voltage to the second deionization electrode 220 using the second terminal 320, the pin terminal 330, and the contact terminal 340, each of the first deionization electrode 210 and the second deionization electrode 220 may provide sufficient deionization performance even when a relatively low voltage is applied to each of the first deionization electrode 210 and the second deionization electrode 220.

In an embodiment where the deionization electrode 200 is not divided into the first deionization electrode 210 and the second deionization electrode 220, applying a voltage between the upper and lower surfaces of the deionization electrode 200 using only the first terminal 310 and the second terminal 320 may result in poor deionization performance, or may require applying a relatively high voltage to achieve sufficient deionization performance.

By using a pair of terminals that penetrate the deionization electrode 200 in the first direction (Z) from the upper surface to the lower surface, and by contacting the terminals throughout the plurality of electrode layers included in the deionization electrode 200, it is possible to achieve sufficient deionization performance even under a relatively low voltage. However, in such an embodiment, the deionization electrode 200 may be more likely to be damaged by the terminals penetrating therethrough. In particular, each of the plurality of electrode layers included in the deionization electrode 200 may include a brittle material, such as a porous carbon electrode, which may be easily damaged when the terminals penetrate therethrough.

In an embodiment of the present disclosure, the deionization electrode 200 may be electrically connected to the terminals by bringing the terminals into contact with the outer surface of the deionization electrode 200 without penetrating the deionization electrode 200. By applying voltages to each of the first deionization electrode 210 and the second deionization electrode 220 to perform the water treatment process, sufficient performance may be achieved even with relatively low applied voltages, thereby improving the deionization performance.

Although an embodiment in which the water treatment device 100 includes two deionization electrodes (the first deionization electrode 210 and the second deionization electrode 220) and the contact terminal 340 is disposed between the first deionization electrode 210 and the second deionization electrode 220 has been described with reference to FIG. 12, embodiments of the present disclosure are not limited thereto. In various embodiments, the water treatment device 100 may include three or more deionization electrodes 200. In this case, a plurality of contact terminals 340 may be provided, and each contact terminal 340 may be disposed between adjacent deionization electrodes 200 of the plurality of deionization electrodes 200.

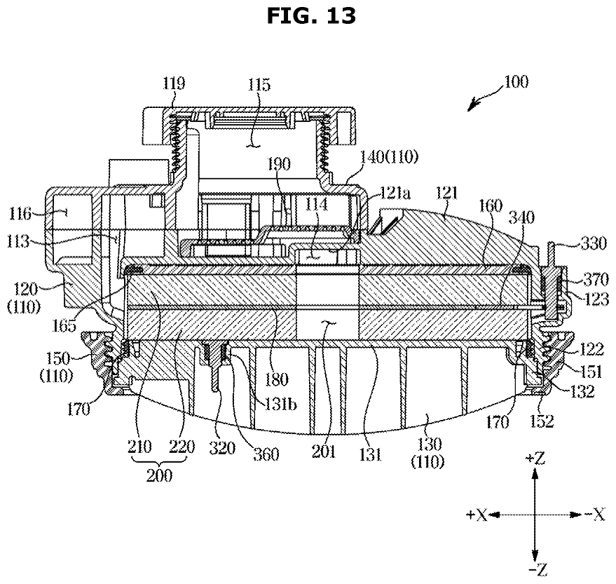

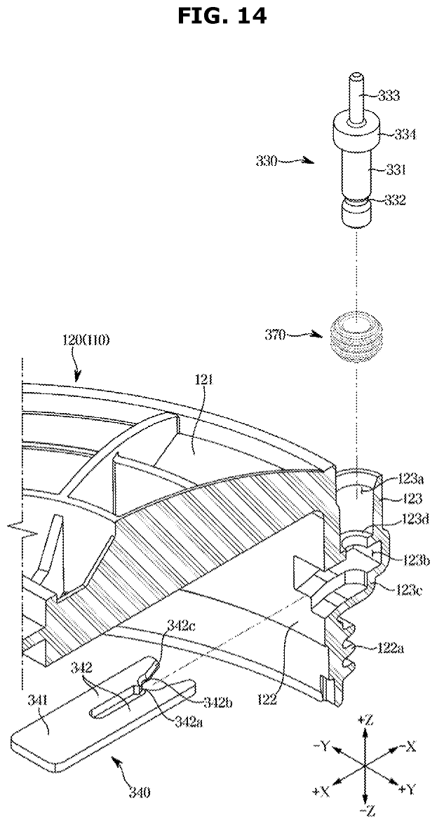

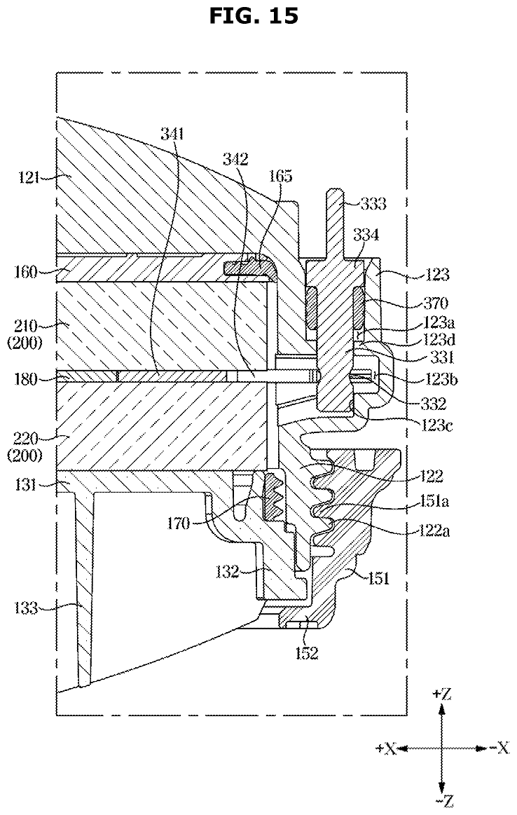

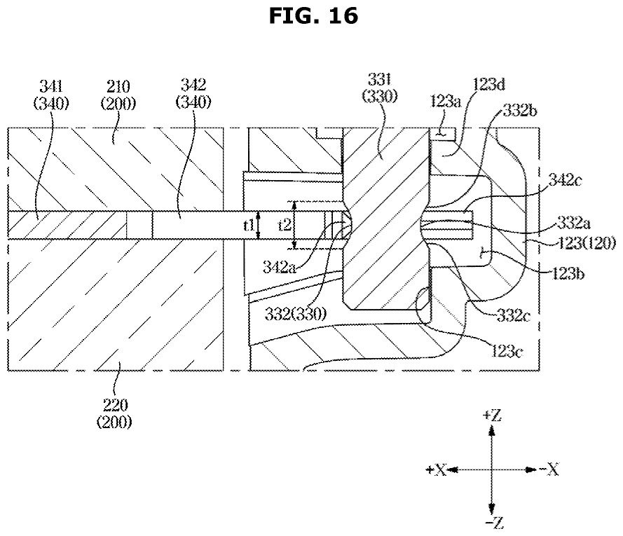

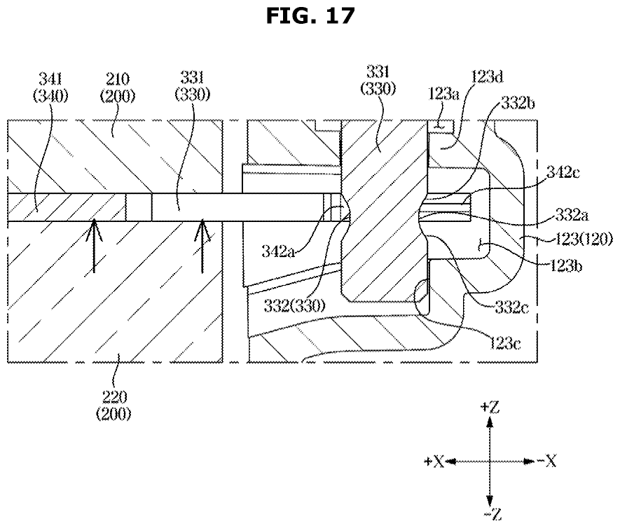

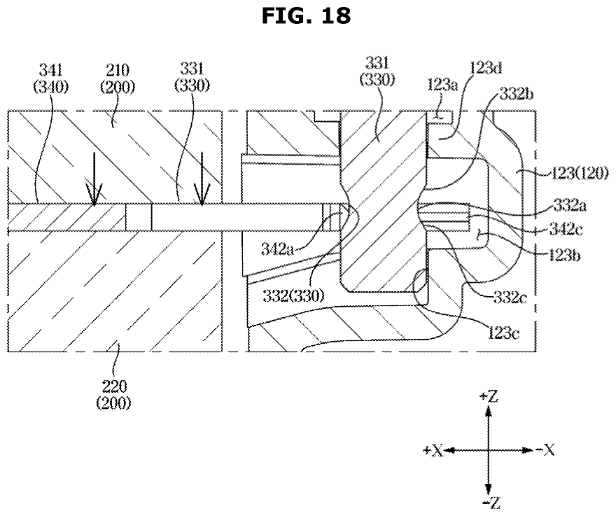

FIG. 13 is a cross-sectional view illustrating the water treatment device of the dishwasher according to an embodiment of the present disclosure. FIG. 14 is an exploded perspective view illustrating various configurations such as a case, a pin terminal, a contact terminal, and a pin terminal seal included in the water treatment device of the dishwasher according to an embodiment of the present disclosure. FIG. 15 is an enlarged cross-sectional view illustrating a part of the water treatment device of the dishwasher according to an embodiment of the present disclosure. FIG. 16 is an enlarged cross-sectional view illustrating a part of the water treatment device of the dishwasher according to an embodiment of the present disclosure. FIG. 17 is an enlarged cross-sectional view illustrating a part of the water treatment device of the dishwasher according to an embodiment of the present disclosure. FIG. 18 is an enlarged cross-sectional view illustrating a part of the water treatment device of the dishwasher according to an embodiment of the present disclosure.

Referring to FIGS. 13 to 18, the water treatment device 100 of the dishwasher 1 according to an embodiment of the present disclosure may include the pin terminal 330 and the contact terminal 340 electrically connected to the deionization electrode 200.

The contact terminal 340 may be disposed inside the case 110. The contact terminal 340 may be in contact with the deionization electrode 200. For example, the contact terminal 340 may be disposed between the first deionization electrode 210 and the second deionization electrode 220 to simultaneously contact the first deionization electrode 210 and the second deionization electrode 220.

The contact terminal 340 may contact the deionization electrode 200 in the first direction (Z-direction). The contact terminal 340 may contact the first deionization electrode 210 and the second deionization electrode 220 in the first direction (Z-direction).

According to an embodiment, in order for the contact terminal 340 to reliably contact the first deionization electrode 210 and the second deionization electrode 220, a thickness of the contact terminal 340 in the first direction (Z) may be greater than or equal to a thickness of the electrode partition 180 in the first direction (Z).

The contact terminal 340 may extend in a direction different from the first direction (Z-direction). For example, the contact terminal 340 may extend in the second direction (X-direction) different from the first direction (Z-direction). In an example, the first direction (Z-direction) and the second direction (X-direction) may be perpendicular to each other, but embodiments of the present disclosure are not limited thereto.

In an example, the contact terminal 340 may have a plate shape substantially perpendicular to the first direction (Z-direction).

The contact terminal 340 may include a contact body 341 in contact with the deionization electrode 200 and a leg portion 342 extending from the contact body 341 toward an outer side of the deionization electrode 200. The contact body 341 may be disposed between the first deionization electrode 210 and the second deionization electrode 220 to contact each of the first deionization electrode 210 and the second deionization electrode 220. In an example, the contact body 341 may be inserted into the terminal groove 182 of the electrode partition 180 in the second direction (X-direction). In an example, the contact body 341 may penetrate the terminal groove 182 of the electrode partition 180 in the first direction (Z-direction). The leg portion 342 may extend from the contact body 341 toward the pin terminal 330. The leg portion 342 may extend from the contact body 341 in the second direction (X-direction). The leg portion 342 may contact the pin terminal 330 on the outer side of the deionization electrode 200. The leg portion 342 may be electrically connected to the pin terminal 330 on the outer side of the deionization electrode 200.

The leg portion 342 may be coupled to the pin terminal 330. At least a portion of the leg portion 342 may be coupled to the pin terminal 330 within a terminal accommodating portion 123. According to an embodiment, the leg portion 342 may include a plurality of extension portions 342 spaced apart from each other. The plurality of leg portions 342 may surround an outer surface of the pin terminal 330. The outer surface of the pin terminal 330 may be fitted between the plurality of leg portions 342. As the pin terminal 330 is fitted between the plurality of leg portions 342, the pin terminal 330 and the contact terminal 340 may be coupled.

The pin terminal 330 may extend in the first direction (Z-direction). The pin terminal 330 may have a pin shape extending substantially in the first direction (Z-direction).

To connect the contact terminal 340 disposed inside the case 110 to the power source P disposed outside the case 110, a portion of the pin terminal 330 may be disposed outside the case 110, and another portion of the pin terminal 330 may be accommodated inside the case 110.

According to an embodiment, the pin terminal 330 may be accommodated in the terminal accommodating portion 123 of the case 110. The pin terminal 330 may be coupled to the terminal accommodating portion 123. The pin terminal 330 may be inserted into the terminal accommodating portion 123. The pin terminal 330 may be inserted into the terminal accommodating portion 123 in the first direction (Z-direction). With the pin terminal 330 being accommodated in the terminal accommodating portion 123 and the terminal accommodating portion 123 protruding outwardly from the circumferential cover portion 122 as described above, an overall size (e.g., horizontal diameter) of the water treatment device 100 may be reduced.

In an example, the terminal accommodating portion 123 may be open at one side in the first direction (Z-direction). In an example, the terminal accommodating portion 123 may be open at an upper side, and the pin terminal 330 may be inserted into the terminal accommodating portion 123 through the open upper side.

According to an embodiment, the water treatment device 100 may include a pin terminal seal 370. The pin terminal seal 370 may be disposed between the pin terminal 330 and the terminal accommodating portion 123. The pin terminal seal 370 may be disposed between an outer circumferential surface of the pin terminal 330 and an inner surface of the terminal accommodating portion 123. The pin terminal seal 370 may contact the outer surface of the pin terminal 330 and the inner surface of the terminal accommodating portion 123.

The pin terminal seal 370 may cover a gap between the pin terminal 330 and the terminal accommodating portion 123 to prevent leakage from the interior of the case 110.

In an example, the pin terminal seal 370 may have a ring shape that substantially surrounds the outer circumferential surface of the pin terminal 330. In an example, the pin terminal seal 370 may have a substantially hollow cylinder shape. In an example, the pin terminal seal 370 may extend in the first direction (Z-direction).

The pin terminal seal 370 may be configured to be elastically deformable. For example, the pin terminal seal 370 may include a variety of elastic materials, such as rubber, elastic resin, or the like.

The terminal accommodating portion 123 may include a first accommodating portion 123a, a second accommodating portion 123b, and a hole partition wall 123d disposed between the first accommodating portion 123a and the second accommodating portion 123b. The hole partition wall 123d may include a hole formed for the pin terminal 330 to penetrate. The pin terminal 330 may penetrate the hole partition wall 123d in the first direction (Z-direction).

A portion of the pin terminal 310 may be accommodated in the first accommodating portion 123a. In an example, the pin terminal 310 may penetrate the first accommodating portion 123a. The pin terminal seal 370 may be disposed in the first accommodating portion 123a. The pin terminal seal 370 may cover a gap between an outer surface of a portion of the pin terminal 330 disposed in the first accommodating portion 123a and an inner surface of the first accommodating portion 123a.

A portion of the pin terminal 310 may be accommodated in the second accommodating portion 123b. A portion of the contact terminal 340 may be accommodated in the second accommodating portion 123b. For example, at least a portion of the leg portion 342 may be disposed within the second accommodating portion 123b. For example, an outer end of the leg portion 342 may be disposed within the second accommodating portion 123b. For example, an end of the leg portion 342 opposite to the contact body 341 may be disposed within the second accommodating portion 123b. The contact terminal 340 and the pin terminal 310 may be coupled within the second accommodating portion 123b.

The first accommodating portion 123a, the hole partition wall 123d, and the second accommodating portion 123b may be arranged in the first direction (Z-direction) relative to each other. In an example, the first accommodating portion 123a may be disposed above the second accommodating portion 123b. The hole partition wall 123d may be disposed on a lower surface of the first accommodating portion 123a and on an upper surface of the second accommodating portion 123b.

A hole formed in the hole partition wall 123d may have a width that is smaller than a width of the first accommodating portion 123a (e.g., a diameter in a direction perpendicular to the first direction (Z-direction)). The hole formed in the hole partition wall 123d may have a width that is smaller than a width of the second accommodating portion 123b (e.g., a diameter in a direction perpendicular to the first direction (Z-direction)). In an example, the hole formed in the hole partition wall 123d may contact the outer surface of the pin terminal 330. In an example, the width of the hole formed in the hole partition wall 123d (e.g., a diameter in a direction perpendicular to the first direction (Z-direction)) may be substantially the same as a width of a pin body 331 of the pin terminal 330 (e.g., in the first direction (Z-direction)). In an example, the hole partition wall 123d may contact the outer surface of the pin terminal 330 to secure the pin terminal 330 so as to restrict the pin terminal 330 from moving in a direction different from the first direction (Z-direction).

The terminal accommodating portion 123 may include a support wall 123c. The support wall 123c may be configured to support the pin terminal 330 inside the case 110. For example, the support wall 123c may be configured to contact the pin terminal 330 in the second direction (X-direction) inside the case 110. The support wall 123c may contact the pin terminal 330 to secure the pin terminal 330 so as to restrict movement of the pin terminal 330 in the second direction (X-direction) to the outside of the case 110.

Based on a position where the contact terminal 340 is coupled to the pin terminal 330, the hole partition wall 123c may be disposed on one side in the first direction (Z-direction), and the support wall 123c may be disposed on the other side. Thereby, the pin terminal 330 may be more reliably supported to prevent movement in the second direction (X-direction), and in particular, the pin terminal 330 may be more effectively prevented from deviating from its designed position, such as moving or rotating in the second direction (X-direction), due to forces applied during the process of coupling the contact terminal 340 to the pin terminal 330.

At least a portion of the second accommodating portion 123b of the terminal accommodating portion 123 may be disposed on an outer side in the second direction (X-direction) than the hole formed in the hole partition wall 123d. At least a portion of the second accommodating portion 123b of the terminal accommodating portion 123 may be disposed on an outer side in the second direction (X-direction) than the support wall 123c. As a result, the leg portion 342 may extend outwardly in the second direction (X-direction) than the hole and/or the support wall 123c formed in the hole partition wall 123d.

The structure of the terminal accommodating portion 123 according to the embodiment of the present disclosure is not limited to that described above, and in various embodiments, the pin terminal 330 may penetrate another portion of the case 110 in the first direction (Z-direction) instead of the terminal accommodating portion 123 protruding outwardly from the circumferential cover portion 122. In such an embodiment, configurations of the first portion 123a and the second portion 123b of the terminal accommodating portion 123, the hole partition wall 123d, the support wall 123c, and the like described above may be disposed in other portions of the case 110.

According to an embodiment, the pin terminal 330 may include the pin body 331. The pin body 331 may extend in the first direction (Z-direction). In an example, the pin body 331 may have a cylinder shape extending substantially in the first direction (Z-direction). The pin terminal seal 370 may surround an outer circumferential surface of the pin body 331.

The pin body 331 may be accommodated in the terminal accommodating portion 123. The pin body 331 may penetrate the hole partition wall 123c.

The pin body 331 may contact the support wall 123c. The pin body 331 may be supported by contacting the support wall 123c in the second direction (X-direction).

According to an embodiment, the pin terminal 330 may include a pin groove 332. The pin groove 332 may be recessed from the outer circumferential surface of the pin terminal 330. The pin groove 332 may be recessed from the outer circumferential surface of the pin body 331. The pin groove 332 may be recessed inwardly from the outer circumferential surface of the pin body 331, and thus a width of the pin terminal 330 (e.g., a diameter in a direction perpendicular to the first direction (Z-direction)) may be smaller at the pin groove 332 than at the pin body 331.

The contact terminal 340 may be coupled to the pin groove 332. For example, the contact terminal 340 and the pin terminal 330 may be coupled to each other by fitting the pin groove 332 between the plurality of leg portions 342. The pin groove 332, being recessed from the outer circumferential surface of the pin body 331, may efficiently guide the coupling position of the contact terminal 340.

To more efficiently guide the coupling position of the contact terminal 340, the pin groove 332 may include a vertical portion 332a aligned with the first direction (Z-direction), and at least one inclined portion (e.g., a first inclined portion 332b or a second inclined portion 332c) extending from the vertical portion 332a in a inclined direction relative to the first direction (Z-direction). For example, the pin groove 332 may include the first inclined portion 332b and the second inclined portion 332c, and the vertical portion 332a may be disposed between the first inclined portion 332b and the second inclined portion 332c. The first inclined portion 332b and the second inclined portion 332c may each extend to be recessed inwardly toward the vertical portion 332a.

According to an embodiment, the pin terminal 330 may include a wire connection portion 333. The wire connection portion 333 may extend from the pin body 331. The wire connection portion 333 may extend from the pin body 331 to the outer side of the case 110. The wire connection portion 333 may extend from the pin body 331 in the first direction (Z-direction) (e.g., upward (+Z direction)). The wire connection portion 333 may be disposed outside the case 110 and connected to a wire for connection to the power source P.

According to an embodiment, the pin terminal 330 may include a seal cover portion 334 that covers the pin terminal seal 370. A width of the seal cover portion 334 (e.g., a diameter in a direction perpendicular to the first direction (Z-direction)) may be larger than a width of the pin body 331.

The seal cover portion 334 may cover the pin terminal seal 370 in the first direction (Z-direction). The seal cover portion 334 may cover the pin terminal seal 370 on an outward side of the first accommodating portion 123a in the first direction (Z-direction). For example, the seal cover portion 334 may cover the pin terminal seal 370 on an open side of the first accommodating portion 123a. For example, the seal cover portion 334 may cover the pin terminal seal 370 from an upper side. The pin terminal seal 370 may be disposed between the seal cover portion 334 and the hole partition wall 123d. The seal cover portion 334 may prevent the pin terminal seal 370 from being deviated from the pin terminal 330.

According to an embodiment of the present disclosure, the pin terminal 330 may support the contact terminal 340 to be movable in the first direction (Z-direction) relative to the case 110. The pin terminal 330 may be configured to be adjustable in the position in the first direction (Z-direction) of the contact terminal 340. The contact terminal 340 may be movably coupled to the pin terminal 330 in the first direction (Z-direction). The position of the contact terminal 340 in the first direction (Z-direction) may vary depending on, for example, a position of each of the first deionization electrode 210 and/or the second deionization electrode 220 in the first direction (Z-direction) relative to the case 110, or a length of each of the first deionization electrode 210 and the second deionization electrode 220. As a result, the position of the contact terminal 340 may be adjusted even when the position or length of the first deionization electrode 210 and the second deionization electrode 220 varies.

According to an embodiment, the contact terminal 340 may be configured to be movable in the first direction (Z-direction) relative to the pin terminal 330. The contact terminal 340 may be movable in the first direction (Z-direction) along the pin terminal 330.

According to an embodiment, the pin terminal 330 may be held to the case 110. The pin terminal 330 may be held in the first direction (Z-direction) relative to the case 110. For example, the pin terminal 330 may be fixed by friction from the pin terminal seal 370 so that it hardly moves in the first direction (Z-direction) relative to the case 110. As such, when the pin terminal 330 is held to the case 110, the possibility of leakage through the terminal accommodating portion 123 may be further reduced. Even when the pin terminal 330 is held to the case 110, the contact terminal 340 may be movable along the pin terminal 330 and thus may be movable in the first direction (Z-direction) relative to the case 110.

According to an embodiment, the contact terminal 340 may be movable in the first direction (Z-direction) while being coupled to the pin groove 332. As shown in FIGS. 17 and 18, the contact terminal 340 may be movable in the first direction (Z-direction) within a range of the pin groove 332. In an example, the contact terminal 340 may be restricted from moving to the outer side of the pin groove 332 by a thickness of the relatively thick pin body 331.

A length t2 of the pin groove 332 in the first direction (Z-direction) may be greater than a length t1 of the contact terminal 340 in the first direction (Z-direction). The length t2 of the pin groove 332 in the first direction (Z-direction) may be greater than the length t1 of the extension portion 342 in the first direction (Z-direction).

With such a structure, the contact terminal 340 may be movable in the first direction (Z-direction) relative to the case 110 while being connected to the pin terminal 330.

However, the embodiments of the present disclosure are not limited to the case where the pin terminal 330 is held to the case 110 and the contact terminal 340 is movable relative to the pin terminal 330, and according to an embodiment, the pin terminal 330 may be movable relative to the case 110. In an embodiment where the pin terminal 330 is movable relative to the case 110, the contact terminal 340 may be movable in the first direction (Z-direction) relative to the pin terminal 330, or may be held such that its movement in the first direction (Z-direction) relative to the pin terminal 330 is restricted. When the contact terminal 340 is held such that its movement in the first direction (Z-direction) relative to the pin terminal 330 is restricted, a movement range of the contact terminal 340 in the first direction (Z-direction) may be restricted, for example, between the hole partition wall 123d and the lower surface of the second accommodating portion 123b.

In contrast to the embodiments described above, according to an embodiment, the pin terminal 330 may not include a separate recessed portion, such as the pin groove 332. In such an embodiment, the pin body 331 may have a uniform width throughout, and the contact terminal 340 may be movable along the pin body 331 in the first direction (Z-direction). In this case, a movement range of the contact terminal 340 in the first direction (Z-direction) may be restricted, for example, between the hole partition wall 123d and the lower surface of the second accommodating portion 123b.

In an embodiment where the contact terminal 340 is inserted into the case 110 in the second direction (X-direction) and directly connected to the power source P, the possibility of leakage through the portion where the contact terminal 340 is coupled may increase. In addition, in such an embodiment, it may be difficult to properly design and assemble the position of the contact terminal 340 relative to the case 110 due to tolerances between the deionization electrode 200 and the case 110. This may be even more so in cases where the deionization electrode 200 includes the plurality of deionization electrodes 210 and 220 as in the embodiment of the present disclosure.

For example, the relative position between the deionization electrode 200 and the case 110 in the first direction (Z-direction) may vary depending on the degree of compression of the deionization electrode 200. In this case, it may be necessary to adjust the position of the contact terminal 340 in the first direction (Z-direction). In an embodiment where the contact terminal 340 is inserted into the case 110 in the second direction (X-direction) and directly connected to the external power source P, the hole on the case 110 through which the contact terminal 340 is inserted in the second direction (X-direction) may be designed to be elongated in the first direction (Z-direction) in order to allow the contact terminal 340 to be easily inserted into the case 110 by overcoming the tolerance relative to the case 110. In such a case, the possibility of leakage through the hole on the case 110 may further increase. Even if a separate seal is provided between the case 110 and the contact terminal 340 to cover the hole on the case 110, the seal may fail to efficiently seal the hole because the position of the contact terminal 340 varies in the first direction (Z-direction) depending on the degree of compression of the deionization electrode 200 or the relative position of the deionization electrode 200 relative to the case 110.

In the embodiment of the present disclosure, since the contact terminal 340 is disposed inside the case 110 and the pin terminal 330 that movably supports the contact terminal 340 in the first direction (Z-direction) is inserted into the case 110 in the first direction (Z-direction), the possibility of leakage from the case 110 may be reduced even if the position of the contact terminal 340 varies in the first direction (Z-direction). Furthermore, since the pin terminal seal 370 may cover relatively evenly the gap between the pin terminal 330 and the terminal accommodating portion 123 even when the contact terminal 340 is movable in the first direction (Z-direction) relative to the pin terminal 330, as well as when the pin terminal 330 is movable in the first direction (Z-direction) relative to the case 110 along with the contact terminal 340, the leakage issues may be more efficiently reduced and/or prevented.

As described above, the contact terminal 340 may be movable in the first direction (Z-direction) relative to the case 110, but may be held such that its movement in a direction different from the first direction (Z-direction) is restricted. For example, the contact terminal 340 may be held in the second direction (X-direction) by the pin terminal 330. For example, the contact terminal 340 may be held in the third direction (Y-direction) by the pin terminal 330. For example, the contact terminal 340 may be coupled to the pin groove 332 of the pin terminal 330 and held such that its movement in a direction different from the first direction (Z-direction) is restricted.

Thus, the contact terminal 340 may be adjustable in position in the first direction (Z-direction), but held in other directions, so that a stable connection with the pin terminal 330 may be maintained.

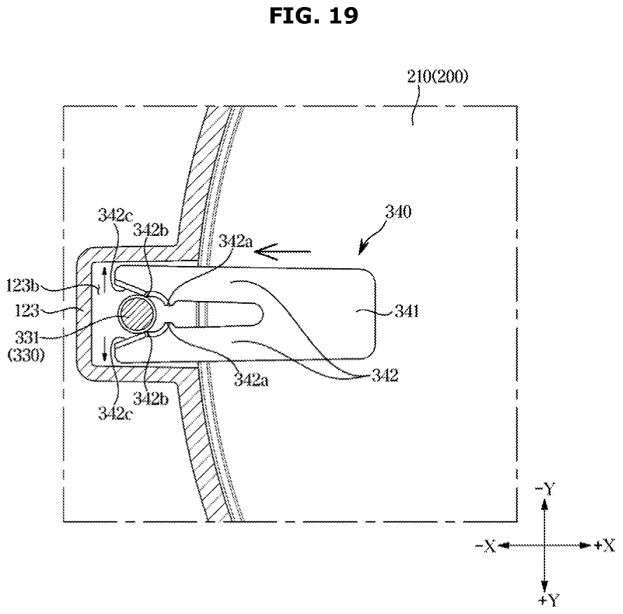

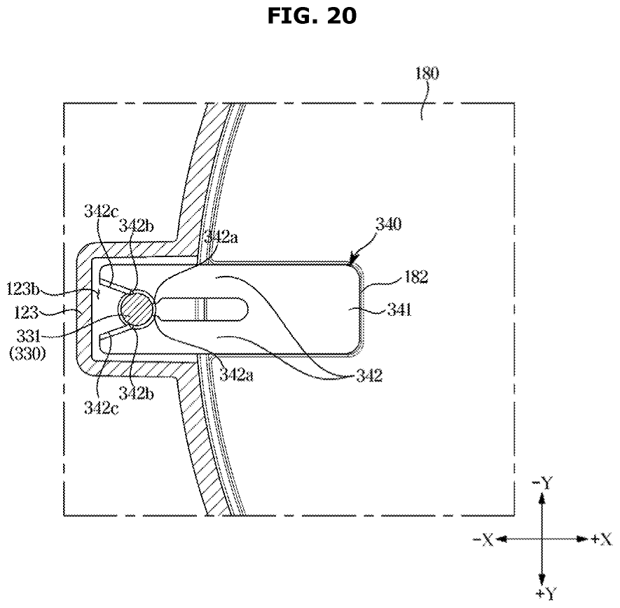

FIG. 19 is a view illustrating various configurations such as a pin terminal and a contact terminal included in the water treatment device of the dishwasher according to an embodiment of the present disclosure, showing a process of coupling the contact terminal to the pin terminal. FIG. 20 is a cross-sectional view illustrating various configurations such as a pin terminal and a contact terminal included in the water treatment device of the dishwasher according to an embodiment of the present disclosure.

Referring to FIGS. 19 and 20, a portion of the contact terminal 340 included in the water treatment device 100 of the dishwasher 1 according to an embodiment of the present disclosure, which is coupled to the pin terminal 330, may be elastically deformable to be easily coupled to the pin terminal 330.

The contact terminal 340 may include the plurality of extension portions 342, and the plurality of extension portions 342 may be elastically deformable by an external force. The plurality of extension portions 342 may be spaced apart from each other and each elastically deformable. In an example, each of the plurality of extension portions 342 may have a thin conductive metal plate shape, which may be elastically deformable by an external force. The plurality of extension portions 342 may be elastically deformed at the step of being coupled to the pin terminal 330, and after being coupled to the pin terminal 330, may be restored by an elastic force and firmly coupled to the pin terminal 330.

According to an embodiment, each of the plurality of extension portions 342 may include a guide portion 342c. The guide portion 342c of each of the plurality of extension portions 342 may extend such that a distance between the guide portions 342c increases as the guide portion moves away from the contact body 341 in the second direction (X-direction). The guide portion 342c may be configured to easily guide the coupling position of the contact terminal 340 relative to the pin terminal 330.

Each of the plurality of extension portions 342 may include protrusions 342a and 342b protruding toward each other.

For example, each of the plurality of extension portions 342 may include an inner protrusion 342a protruding toward each other. A distance between the inner protrusions 342a included in each of the plurality of extension portions 342 may be shorter than the thickness of the pin terminal 330 (e.g., a diameter in a direction perpendicular to the first direction (Z-direction)). Thus, the pin terminal 330 may contact the inner protrusions 342a included in each of the plurality of extension portions 342 in the second direction (X-direction). For example, the inner protrusions 342a included in each of the plurality of extension portions 342 may contact the pin groove 332 in the second direction (X-direction).

For example, each of the plurality of extension portions 342 may include an outer protrusion 342b protruding toward each other. A distance between the outer protrusions 342b included in each of the plurality of extension portions 342 may be shorter than the thickness of the pin terminal 330 (e.g., a diameter in a direction perpendicular to the first direction (Z-direction)). Thus, the pin terminal 330 may contact the outer protrusions 342b included in each of the plurality of extension portions 342 in the second direction (X-direction). For example, the outer protrusions 342b included in each of the plurality of extension portions 342 may contact the pin groove 332 in the second direction (X-direction).

The outer protrusions 342b may be disposed on an outer side of the case 110 in the second direction (X-direction) than the inner protrusions 342a. For example, the inner protrusions 342a may be disposed between the outer protrusions 342b and the contact body 341. For example, the outer protrusions 342b may be disposed between the guide portions 342c and the inner protrusions 342a.

With such a structure, the pin terminal 330 may be gripped i.e., sandwiched between the inner protrusions 342a and the outer protrusions 342b, and the contact terminal 340 may be prevented from easily deviating from the pin terminal 330 after being coupled to the pin terminal 330.

As shown in FIG. 19, the contact terminal 340 may be coupled to the pin terminal 330 in the second direction (X-direction). The contact terminal 340 may be coupled to the pin terminal 330 in a direction from the inner side toward the outer side of the case 110. During the movement of the contact terminal 340 in the second direction (X-direction), the plurality of extension portions 342 may be elastically deformed and spread apart as the guide portions 342c come into contact with the pin terminal 330, and then, as the outer protrusions 342b pass over the center of the pin terminal 330, the plurality of extension portions 342 may be restored by an elastic force and contract again to surround the outer surface of the pin terminal 330. The pin terminal 330 may be fitted between the plurality of extension portions 342 while being engaged by the inner protrusions 342a and the outer protrusions 342b. Thus, the contact terminal 340 may be coupled to the pin terminal 330 and firmly held such that its movement in a direction different from the first direction (Z-direction) is restricted.

In a method of assembling the water treatment device 100 according to an embodiment, the pin terminal 330 may be first inserted into the terminal accommodating portion 123 of the first case 110 and then the contact terminal 340 may be coupled to the pin terminal 330. When inserting the pin terminal 330 into the terminal accommodating portion 123 of the first case 110, the pin terminal seal 370 may be in a state of being coupled to the outer circumferential surface of the pin terminal 330. In a step prior to coupling the contact terminal 340 to the pin terminal 330, a step of coupling the flow path partition 160 to the first case 120 and receiving the first deionization electrode 210 in the first case 120 may be performed first. The step of coupling the contact terminal 340 to the pin terminal 330 may be performed before the electrode partition 180 and the second deionization electrode 220 are accommodated within the first case 120. After coupling the contact terminal 340 to the pin terminal 330, the electrode partition 180 and the second deionization electrode 220 may be sequentially positioned, and the second case 130 may be coupled to the first case 120.

In describing embodiments of the present disclosure with reference to FIGS. 1 to 20, the above has been described with reference to an embodiment in which the water treatment device 100 includes the first deionization electrode 210 and the second deionization electrode 220, and the pin terminal 330 and the contact terminal 340 are electrically connected to the first deionization electrode 210 and the second deionization electrode 220. However, the embodiments of the present disclosure are not limited thereto, and in various embodiments, the water treatment device 100 may include three or more deionization electrodes 200 that are electrically insulated from each other. In this case, the pin terminal 330 and the contact terminal 340 may be electrically connected to only some of the three or more deionization electrodes, or may be electrically connected to each of the three or more deionization electrodes. Alternatively, in various embodiments, the pin terminal 330 and the contact terminal 340 may contact only one deionization electrode. In various embodiments, there may be limitations in designing the terminal to penetrate the case 110 in the first direction (Z-direction) and contact one surface of the deionization electrode due to issues such as the position or structure of the case 110, or interference with other configurations, and in such a case, the power source P may be easily electrically connected to a single deionization electrode by using the pin terminal 330 and the contact terminal 340.

According to an embodiment of the present disclosure, a water treatment device may include: a case including an inlet port and an outlet port; a plurality of deionization electrodes accommodated in the case and configured to adsorb ionic substances from water entering the case through the inlet port, the plurality of deionization electrodes including a first deionization electrode and a second deionization electrode arranged in a first direction relative to each other; a first terminal electrically connected to the first deionization electrode; a second terminal electrically connected to the second deionization electrode; a contact terminal disposed between the first deionization electrode and the second deionization electrode inside the case, and configured to be electrically connected by contacting each of the first deionization electrode and the second deionization electrode in the first direction; and a pin terminal coupled to the contact terminal and configured to electrically connect the contact terminal to a power source outside the case.

The pin terminal may movably support the contact terminal in the first direction relative to the case.

The pin terminal may be held to the case. The contact terminal may be movable in the first direction relative to the pin terminal.

The pin terminal may include a pin groove recessed from an outer circumferential surface of the pin terminal. The contact terminal may be coupled to the pin groove.

A length of the pin groove in the first direction may be greater than a length of the contact terminal in the first direction.

The pin terminal may hold the contact terminal to restrict movement of the contact terminal in a second direction different from the first direction.

The case may support the pin terminal to restrict movement of the pin terminal in the second direction.

The case may include a terminal accommodating portion in which at least a portion of the pin terminal is accommodated.

A portion of the contact terminal and the pin terminal may be coupled within the terminal accommodating portion.

The case may further include a circumferential cover portion configured to cover a circumferential surface of the plurality of deionization electrodes. The terminal accommodating portion may be disposed outwardly of the circumferential cover portion in a direction different from the first direction.

The pin terminal may be inserted into the terminal accommodating portion in the first direction.

The water treatment device may further include a pin terminal seal disposed between an outer surface of the pin terminal and an inner surface of the terminal accommodating portion.

The contact terminal may include a contact body configured to contact the first deionization electrode and the second deionization electrode, and a plurality of leg portions extending from the contact body toward an outside of the deionization electrode and spaced apart from each other.

The pin terminal may be coupled to the contact terminal with an outer surface of the pin terminal fitted between the plurality of leg portions.

The water treatment device may further include an electrode partition disposed between the first deionization electrode and the second deionization electrode and including an insulating material.

According to an embodiment of the present disclosure, a dishwasher may include: a tub; a spraying device configured to spray washing water into an interior of the tub; a sump configured to receive washing water to be supplied to the spraying device; and a water treatment device configured to treat washing water to be supplied to the sump. The water treatment device may include: a case; a first deionization electrode accommodated in the case; a second deionization electrode disposed in a first direction of the first deionization electrode; a first terminal in contact with one side of the first deionization electrode; a second terminal in contact with one side of the second deionization electrode; a contact terminal in contact with the other side of the first deionization electrode and the other side of the second deionization electrode in the first direction inside the case; and a pin terminal configured to electrically connect the contact terminal to a power source outside the case, wherein the pin terminal is coupled to the contact terminal in a second direction different from the first direction.

The contact terminal may include a contact body in contact with the other side of the first deionization electrode and the other side of the second deionization electrode in the first direction, respectively, and a leg portion extending from the contact body in the second direction and coupled to the pin terminal.

The water treatment device may further include an electrode partition disposed between the first deionization electrode and the second deionization electrode. The electrode partition may include a terminal groove formed such that the contact body penetrates in the first direction to contact the other side of the first deionization electrode and the other side of the second deionization electrode.

According to an embodiment of the present disclosure, a water treatment device may include: a case including an inlet port and an outlet port; a deionization electrode accommodated in the case and configured to adsorb ionic substances from water entering the case through the inlet port; a contact terminal in contact with the deionization electrode inside the case and electrically connected to the deionization electrode; and a pin terminal configured to electrically connect the contact terminal to a power source, wherein the pin terminal is configured to movably support the contact terminal in a first direction relative to the case and hold the contact terminal to restrict movement of the contact terminal in a second direction different from the first direction.

The case may include a terminal accommodating portion configured to receive at least a portion of the pin terminal. The terminal accommodating portion may be configured to contact the pin terminal in the second direction to restrict movement of the pin terminal in the second direction.

According to the concept of the present disclosure, the water treatment device of the dishwasher may include the deionization electrode, thereby adsorbing ionic substances from raw water passing through the deionization electrode and softening efficiently the raw water.

According to the concept of the present disclosure, the water treatment device of the dishwasher may include the plurality of deionization electrodes and be configured to apply a voltage to each of the plurality of deionization electrodes, thereby efficiently performing the water treatment operation even when a relatively low voltage is applied.

According to the concept of the present disclosure, in the water treatment device of the dishwasher, the terminals may each contact the outer surface of the deionization electrode without penetrating the deionization electrode to efficiently reduce and/or prevent damage to the deionization electrode when a voltage is applied to the deionization electrode.

According to the concept of the present disclosure, the water treatment device of the dishwasher may include the pin terminal connected to a power source and the contact terminal contacting the deionization electrode, and the contact terminal may be movable relative to the case while contacting the deionization electrode and being coupled to the pin terminal, so that the terminal may be reliably connected to the deionization electrode even when tolerances occur between components.

According to the concept of the present disclosure, the water treatment device of the dishwasher may include the pin terminal seal disposed between the pin terminal and the case, so that the gap between the pin terminal and the case may be efficiently sealed, and issues such as leakage may be efficiently reduced or prevented.

According to the concept of the present disclosure, the pin terminal included in the water treatment device of the dishwasher may include the pin groove configured for the contact terminal to be coupled thereto, so that the contact terminal may be easily coupled to the pin terminal.

According to the concept of the present disclosure, the contact terminal included in the water treatment device of the dishwasher may include the plurality of leg portions, and the outer surface of the pin terminal may be gripped between the plurality of leg portions so that the contact terminal and the pin terminal may be coupled, thereby allowing the contact terminal to be easily coupled to the pin terminal.

The effects to be obtained from the present disclosure are not limited to the effects mentioned above, and other unmentioned effects can be clearly understood by those of ordinary skill in the art to which the present disclosure pertains from the description below.

While the present disclosure has been particularly described with reference to exemplary embodiments, it should be understood by those of skilled in the art that various changes in form and details may be made without departing from the spirit and scope of the present disclosure.

1. A water treatment device comprising:
a case including an inlet port configured to allow water to be introduced into the water treatment device and an outlet port configured to allow the water to be discharged from the water treatment device;
a plurality of deionization electrodes to be accommodated in the case and configured to adsorb ionic substances from the water entering through the inlet port, the plurality of deionization electrodes comprising a first deionization electrode and a second deionization electrode;
a first terminal to be electrically connected to the first deionization electrode;
a second terminal to be electrically connected to the second deionization electrode;
a contact terminal, between the first deionization electrode and the second deionization electrode, configured to be electrically connected by contacting at least the first deionization electrode and the second deionization electrode along a direction in which the first deionization electrode and the second deionization electrode are arranged relative to each other within the case; and
a pin terminal, coupleable to the contact terminal, configured to electrically connect at least one of the contact terminal, the first deionization electrode and the second deionization electrode to a power source, the power source configured to be outside the case.

2. The water treatment device of claim 1, wherein
the pin terminal is configured to movably support the contact terminal in the direction relative to the case.

3. The water treatment device of claim 2, wherein
the pin terminal is held to the case, and
the contact terminal is movable in the direction relative to the pin terminal.

4. The water treatment device of claim 1, wherein the pin terminal comprises:
a pin groove recessed from an outer circumferential surface of the pin terminal, and
the contact terminal is coupleable to the pin groove.

5. The water treatment device of claim 4, wherein
a length of the pin groove in the direction is greater than a length of the contact terminal in the direction.

6. The water treatment device of claim 1, wherein
the direction is a first direction, and
the pin terminal is configured to hold the contact terminal to restrict movement of the contact terminal in a second direction.

7. The water treatment device of claim 6, wherein
the case is configured to support the pin terminal to restrict movement of the pin terminal in the second direction.

8. The water treatment device of claim 1, wherein
the case comprises a terminal accommodating portion configured to accommodate at least a portion of the pin terminal.

9. The water treatment device of claim 8, wherein
at least a portion of the contact terminal and the at least a portion of the pin terminal are coupleable within the terminal accommodating portion.

10. The water treatment device of claim 8, wherein
the case further comprises a circumferential cover portion configured to cover a circumferential surface of the plurality of deionization electrodes, and
the terminal accommodating portion protrudes outwardly from the circumferential cover portion in a direction different from the direction.

11. The water treatment device of claim 8, wherein
the pin terminal is insertable into the terminal accommodating portion in the direction.

12. The water treatment device of claim 8, further comprising:
a pin terminal seal between an outer surface of the pin terminal and an inner surface of the terminal accommodating portion.

13. The water treatment device of claim 1, wherein the contact terminal comprises:
a contact body configured to contact the plurality of deionization electrodes, and
a plurality of leg portions, extending from the contact body toward an outer side of the plurality of deionization electrodes, spaced apart from each other.

14. The water treatment device of claim 13, wherein
the pin terminal is coupleable to the contact terminal with an outer surface of the pin terminal between the plurality of leg portions.

15. The water treatment device of claim 1, further comprising:
an electrode partition between the first deionization electrode and the second deionization electrode and comprising an insulating material.
